(19) United States
(12) Patent Application Publication
(10) Pub. No.: US 2024/0277055 A1
(43) Pub. Date: Aug. 22, 2024

(54) Heat Not Burn Vaporizer Devices

(71) Applicant: JUUL Labs, Inc., Washington, DC (US)

(72) Inventors: Ariel Atkins, San Francisco, CA (US); Brandon Cheung, San Francisco, CA (US); Steven Christensen, Burlingame, CA (US); Jason King, San Francisco, CA (US); Joshua A. Kurzman, San Francisco, CA (US); Esteban Leon Duque, Berkeley, CA (US); Kevin Lomeli, San Francisco, CA (US); Matthew Rios, San Francisco, CA (US)

(21) Appl. No.: 18/649,161

(22) Filed: Apr. 29, 2024

Related U.S. Application Data
(63) Continuation of application No. PCT/US2022/048341, filed on Oct. 31, 2022.
(60) Provisional application No. 63/410,693, filed on Sep. 28, 2022.
(60) Provisional application No. 63/274,922, filed on Nov. 2, 2021.

(51) Int. Cl. A24F 40/46; A24D 3/04; A24D 3/17; A24F 7/00; A24F 40/42; A24F 40/485; H05B 3/06

(52) U.S. Cl. CPC A24F 40/46; A24D 3/043; A24D 3/17; A24F 7/00; A24F 40/42; A24F 40/485; H05B 3/06; H05B 2203/007

(57) ABSTRACT

Vaporizer devices for generating an inhalable aerosol are provided. In one exemplary embodiment, a vaporizer device can include a receptacle, one or more heating elements positioned to heat the receptacle, and a cartridge configured to be inserted into the receptacle. The cartridge can include a container configured to heat vaporizable material when the heating element heats the receptacle, a lid with a plurality of first air inlets configured to direct air into the container, and a structure within the container, in which the structure is configured to direct the air through the vaporizable material to form a vaporized material.

### CROSS-REFERENCE TO RELATED APPLICATIONS

This application claims priority to U.S. Provisional Patent Application Nos. 63/274,922 and 63/410,693, filed on Nov. 2, 2021 and Sep. 28, 2022, respectively, and entitled “Heat Not Burn Vaporizer Devices” the disclosures of which are incorporated herein by reference in their entirety.

### TECHNICAL FIELD

The subject matter described herein relates to vaporizer devices, including vaporizer devices comprising a vaporizer body configured to heat a cartridge of vaporizable material.

### BACKGROUND

Vaporizer devices, which can also be referred to as vaporizers, electronic vaporizer devices, or e-vaporizer devices, can be used for delivery of an aerosol (for example, a gas-phase and/or a condensed-phase material suspended in a stationary or moving mass of air or some other gas carrier) containing one or more active ingredients by inhalation of the aerosol by a user of the vaporizer device. For example, electronic nicotine delivery systems (ENDS) include a class of vaporizer devices that are battery powered and that can be used to simulate the experience of smoking, but without burning of tobacco or other substances. Vaporizer devices are gaining increasing popularity both for prescriptive medical use, in delivering medicaments, and for consumption of tobacco, nicotine, and other plant-based materials. Vaporizer devices can be portable, self-contained, and/or convenient for use.

In use of a vaporizer device, the user inhales an aerosol, colloquially referred to as “vapor,” which can be generated by a heating element that vaporizes (e.g., causes a liquid or solid to at least partially transition to the gas phase) a vaporizable material, which can be liquid, a solution, a solid, a paste, a wax, and/or any other form compatible for use with a specific vaporizer device. The vaporizable material used with a vaporizer device can be provided within a cartridge (e.g., a separable part of the vaporizer device that contains vaporizable material) that includes an outlet (e.g., a mouthpiece or an outlet in fluid communication with a mouthpiece) for inhalation of the aerosol by a user.

To receive an inhalable aerosol generated by a vaporizer device, a user may, in certain examples, activate the vaporizer device by taking a puff, by pressing a button, and/or by some other approach. A puff as used herein can refer to inhalation by the user in a manner that causes a volume of air to be drawn into the vaporizer device such that the inhalable aerosol is generated by a combination of vaporized material (e.g., gas-phase material) with the volume of air.

An approach by which a vaporizer device generates an inhalable aerosol from a vaporizable material involves heating the vaporizable material (e.g., within a cartridge, an insert, a vaporization chamber, a heater chamber, an oven, and/or a compartment associated with a heating element) to cause at least a portion of the vaporizable material to be converted to vaporized material (e.g., gas-phase material). A vaporization chamber, heater chamber, oven, or the like can refer to an area or volume in the vaporizer device within which a heat source (for example, a conductive, convective, and/or radiative heat source) causes heating of a vaporizable material to produce a vaporized material and allow the vaporized material to mix with air to form an aerosol for inhalation by a user of the vaporizer device.

Vaporizer devices can be controlled by one or more controllers, electronic circuits (for example, sensors, heating elements, buttons, switches), and/or the like on or in the vaporizer device. Vaporizer devices can also wirelessly communicate with an external controller (e.g., a computing device such as a personal computer or smartphone).

In some implementations, vaporizer cartridges that contain solid vaporizable material (e.g., comprising plant material such as tobacco leaves and/or parts of tobacco leaves) must be heated to undesirably high temperatures in order to cause inner regions of the vaporizable material to be heated to a minimum temperature required for vaporization. As a result, portions of the solid vaporizable material contained within a vaporizer cartridge can burn or char at these high temperatures and produce combustion or partial combustion byproducts (e.g., chemical elements or chemical compounds) that may have undesirable characteristics, such as unpleasant smells or tastes, negative health impacts, etc. Furthermore, uniform heating of the vaporizable material in current conduction-based vaporizers may be difficult to achieve due to the low thermal conductivity of certain vaporizable materials (e.g., plant materials, such as tobacco). Accordingly, controlled and even distribution of heat is desirable in such devices.

Conduction-based vaporizer devices may be configured to convert to the gas phase one or more compounds present in vaporizable material that includes a liquid component (e.g., solid material soaked in a liquid solution, at least partially saturated with a liquid solution, dipped in a liquid solution, treated with a liquid solution, and/or the like), using a heating element that contacts the vaporizable material. As such, the liquid component can contaminate the heating element. This contamination can ultimately compromise performance of the vaporizer device. Some vaporizers may incorporate the heating element into the disposable part of the vaporizer device (e.g., the cartridge), such that the heating element may be replaced with each new cartridge and thereby limit, but not eliminate, heating element contamination. However, this can increase manufacturing labor and costs associated with the disposable part.

Some issues with current vaporizer devices include the inability to efficiently and effectively heat the vaporizable material without wasting a significant amount of energy. For example, some vaporizer devices include a heater body wrapped around an external surface of a tobacco material and placed directly in an airstream. Such a configuration may cause one or more heater surfaces to be exposed to the airstream, thereby losing at least a portion of thermal energy produced by the heater that could have been used to heat the tobacco material. As such, energy may be wasted as the generated heat is not effectively utilized.

Vaporizer devices configured to embed some or part of a heater apparatus inside of the tobacco material may include airflow passing through the tobacco material thereby prohibiting tight tobacco compaction around the heater, thus diminishing heat transfer from the heater to the tobacco material. Furthermore, vaporizer devices with a heater element embedded within or at least partially surrounded by the tobacco may also experience cleaning and hygiene issues. For example, as the heater pierces the tobacco, residue may be left on the heater element after use, thereby requiring the user to clean the heater element before continued use.

### SUMMARY

Aspects of the current subject matter relate to vaporizer devices including various implementation of a vaporizer body and/or cartridge of vaporizable material configured to generate an inhalable aerosol. For purposes of summarizing, certain aspects, advantages, and novel features have been described herein. It is to be understood that not all such advantages may be achieved in accordance with any one particular implementation. Thus, the disclosed subject matter may be implemented, embodied, or carried out in a manner that achieves or optimizes one advantage or group of advantages without achieving all advantages as may be taught or suggested herein. The various features and items described herein may be incorporated together or separable, except as would not be feasible based on the current disclosure and what a skilled artisan would understand from it.

In various implementations, a vaporizer device (e.g., for generating an inhalable aerosol) includes a receptacle, one or more heating elements positioned to heat the receptacle, a cartridge configured to be inserted into the receptacle, and a mouthpiece. The cartridge includes a container comprising vaporizable material and the container is configured to, at least in part, heat the vaporizable material when the heating element heats the receptacle. The cartridge can additionally include a lid having a plurality of first air inlets configured to direct air into the container and/or at least one air outlet. The cartridge further includes a structure within the container, the structure configured to direct the air through the vaporizable material to form a vaporized material and/or direct the vaporized material towards the at least one air outlet. The cartridge further includes at least one condensation chamber configured to condense the vaporized material into an inhalable aerosol, where the at least one condensation chamber is in fluid communication with the at least one air outlet. The mouthpiece can include a mouthpiece outlet configured to deliver an inhalable aerosol to a user, and/or the mouthpiece outlet can be in fluid communication with the at least one condensation chamber.

In interrelated implementations, which may be included in a vaporizer device of any of the implementations described, the receptacle comprises an oven. Optionally, the one or more heating elements are positioned at, against, near, and/or along one or more walls of the receptacle. The one or more walls of the receptacle can include a bottom receptacle wall that is distal to the mouthpiece and/or one or more side walls extending in a longitudinal dimension that is perpendicular to the bottom receptacle wall.

In optional variants of the implementations described, a heating element of the one or more heating elements extends along at least a portion of the one or more side walls of the receptacle and/or a heating element of the one or more heating elements is wrapped around at least a portion of an exterior of the receptacle. In optional variants of the implementations described, a heating element of the one or more heating elements extends along at least a portion of the bottom receptacle wall. Any of the heating element(s) may be the same heating element or separate heating elements. Optionally the heating element(s) may be flexible heating circuit(s) and/or ceramic heater(s). The heating element(s) may be in direct contact with the cartridge or indirect contact with the cartridge (e.g., in thermal contact with but not physically touching the cartridge). For example, one or more flexible heating circuit(s) can be in contact with and/or wrapped around at least a portion (e.g., majority or minority) of the surfaces of the side walls and/or bottom wall of the receptacle or oven. In another example, a ceramic heater may additionally or alternatively be positioned at (or at least partially form) the bottom wall of the receptacle or oven.

In optional variants of the implementations described, the cartridge includes one or more side walls extending between a proximal end and a distal end of the cartridge (e.g., opposite ends) and/or a bottom container wall at or near (e.g., proximate) the distal end of the cartridge. Optionally, the lid includes a top barrier at or near (e.g., proximate) the proximal end of the cartridge. The lid can include a base component that includes a shaft having one or more shaft through-holes.

In optional variants of the implementations described, the container, lid (e.g., top barrier, perforated lid, and/or base component), and/or other components of the cartridge can be formed of or otherwise include non-vapor permeable material, such as metal, metal alloy, paper material such as cardstock, corrugated material such as cardboard, tobacco paper, temperature-resistant plastic, and/or the like. If a metal or metal alloy is used, it can include aluminum and/or stainless steel. In optional variants of the implementations described, at least a portion of the lid (e.g., a top barrier, perforated lid, and/or base component) can include paper material and the container and other portions of the lid (perforated lid and/or base component) can include aluminum or stainless steel.

In interrelated implementations, which may be included in a vaporizer device of any of the implementations described, the vaporizer device includes at least one airflow path configured to deliver the inhalable aerosol to the user. In optional variants of the implementations described, the structure (of the cartridge) includes a baffle or a shaft having a plurality of shaft through-holes. In other optional variants of the implementations described, the airflow path includes the plurality of air inlets, the plurality of through-holes, the at least one condensation chamber, the at least one air outlet, the mouthpiece outlet, and/or the plurality of shaft through-holes. In optional variants of the implementations described, the shaft includes (one or more of) the at least one condensation chamber, and (one or more of) the at least one condensation chamber is in fluid communication with (one or more of) the plurality of air inlets, which are configured to direct air into (one or more of) the at least one condensation chamber to promote nucleation of the vaporized material into an inhalable aerosol.

In optional variants of the implementations described, the mouthpiece includes (one or more of) the at least one condensation chamber and includes or forms at least a portion of at least one air inlet in fluid communication with (one or more of) the at least one condensation chamber. The at least one air inlet is configured to direct air into (one or more of) the at least one condensation chamber to promote nucleation of the vaporized material into the inhalable aerosol.

In optional variants of the implementations described, the mouthpiece includes or forms at least a portion an air inlet configured to direct air into the vaporizer device. In optional variants of the implementations described, the lid includes at least one second air inlet configured to direct air toward a combined airflow path of the vaporized material to thereby promote nucleation of the vaporized material into the inhalable aerosol. In some aspects of implementations described, the directed air mixes with the combined airflow path within at least a portion of the cartridge, outside of the cartridge, or both.

In optional variants of the implementations described, the structure (of the cartridge) includes at least one first hole and at least one second hole, with the at least one first hole being configured to direct the air passing through the plurality of air inlets of the lid into the container and the at least one second hole being configured to direct the vaporized material toward the at least one air outlet of the lid. The combination of the at least one first hole and the at least second hole allows air ingress and air egress into and out of the cartridge through the lid. Optionally, air ingress through the at least first hole passes through the lid in a first direction and air egress through the at least one second holes passes through the lid in a second direction that is different than the first direction (e.g., opposite directions relative to each other).

In interrelated implementations, which may be included in a vaporizer device of any of the implementations described, the vaporizable material can include solid plant-based material, such as tobacco. In optional variants of the implementations described, the vaporizable material includes both a tobacco substance and a non-tobacco substance. Optionally, the tobacco substance includes tobacco leaves and the non-tobacco substance includes a substance with similar characteristics to the tobacco substance. The similar characteristics can include a heat transfer profile of the tobacco substance, an air transfer profile of the tobacco substance, a capillary pressure profile of the tobacco substance, a porosity profile of the tobacco substance, and/or the like. For example, the substance can include puffed-up tobacco stems, hemp, cotton, wood, porous glass beads, a porous ceramic, and/or the like. Optionally, the tobacco leaves include dried or dehydrated tobacco leaves.

In optional variants of the implementations described, the tobacco substance and the non-tobacco substance are formed and/or layered in sheets and/or strands. Optionally, the non-tobacco substance is formed into pellets, boluses, and/or beads interspersed within the tobacco substance. Also optionally, the tobacco substance and the non-tobacco substance are mixed together into a homogenous or non-homogenous mixture. In interrelated implementations, which may be included in a vaporizer device of any of the implementations described, the structure includes a filter upstream of the at least one air outlet.

In optional variants of the implementations described, the structure is further configured to direct the vaporized material towards the at least one air outlet.

In optional variants of the implementations described, the at least one condensation chamber is positioned within the cartridge.

In optional variants of the implementations described, the lid includes a filter assembly. Optionally, the filter assembly includes a first layer and an absorbent layer, in which the at least one condensation chamber is defined within the absorbent layer. Also optionally, the filter assembly further includes a second layer, in which the absorbent layer is positioned between the first layer and the second layer. Also optionally, each of the first layer, second layer, and absorbent layer has at least one through-hole extending therethrough. Optionally, the absorbent layer includes at least one aeration hole, in which the at least one aeration hole is in fluid communication with the condensation chamber.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. The patent or application file contains at least one drawing executed in color. Copies of this patent or patent application with color drawing(s) will be provided by the Office upon request and payment of the necessary fec. In the drawings:

FIG. 1 illustrates a block diagram of a vaporizer device, consistent with implementations of the current subject matter;

FIG. 2A illustrates a perspective view of an implementation of a vaporizer device, consistent with implementations of the current subject matter;

FIG. 2B illustrates another perspective view of the vaporizer device of FIG. 2A, in which the mouthpiece is removed;

FIG. 3 illustrates a front view of an implementation of a cartridge, consistent with implementations of the current subject matter;

FIG. 4A illustrates a front cross-sectional view of a vaporizer device, consistent with implementations of the current subject matter;

FIG. 4B illustrates a front cross-sectional view of a vaporizer device, consistent with implementations of the current subject matter;

FIG. 4C illustrates a front cross-sectional view of a vaporizer device, consistent with implementations of the current subject matter;

FIG. 4D illustrates a front cross-sectional view of a vaporizer device, consistent with implementations of the current subject matter;

FIG. 4E illustrates a front cross-sectional view of a vaporizer device, consistent with implementations of the current subject matter;

FIG. 4F illustrates a front cross-sectional view of a vaporizer device, consistent with implementations of the current subject matter;

FIG. 4G illustrates a front cross-sectional view of a vaporizer device, consistent with implementations of the current subject matter;

FIG. 4H illustrates a front cross-sectional view of a vaporizer device, consistent with implementations of the current subject matter;

FIG. 4I illustrates a front cross-sectional view of a vaporizer device, consistent with implementations of the current subject matter;

FIG. 5A illustrates a perspective cross-sectional view of a vaporizer device, consistent with implementations of the current subject matter;

FIG. 5B illustrates a front cross-sectional view of a vaporizer device, consistent with implementations of the current subject matter;

FIG. 6 illustrates a front cross-sectional view of a vaporizer cartridge, consistent with implementations of the current subject matter;

FIG. 7A illustrates a top perspective view of a vaporizer cartridge, consistent with implementations of the current subject matter;

FIG. 7B illustrates a bottom perspective view of a vaporizer cartridge, consistent with implementations of the current subject matter;

FIG. 8A illustrates a top perspective view of a vaporizer cartridge, consistent with implementations of the current subject matter;

FIG. 8B illustrates a cross-sectional view of the vaporizer cartridge of FIG. 8A;

FIG. 9 illustrates a partially exploded view of the vaporizer cartridge of FIG. 8A;

FIG. 10 illustrates a top perspective cross-sectional view of a filter assembly of the vaporizer cartridge of FIG. 8A;

FIG. 11 illustrates a magnified view of the vaporizer cartridge of FIG. 8B;

FIG. 12 illustrates a front cross-sectional view of a vaporizer cartridge, consistent with implementations of the current subject matter;

FIG. 13A illustrates a front cross-sectional view of a vaporizer cartridge, consistent with implementations of the current subject matter;

FIG. 13B illustrates a front cross-sectional view of a vaporizer cartridge, consistent with implementations of the current subject matter;

FIG. 13C illustrates a front cross-sectional view of a vaporizer cartridge, consistent with implementations of the current subject matter;

FIG. 13D illustrates a front cross-sectional view of a vaporizer cartridge, consistent with implementations of the current subject matter;

FIG. 13E illustrates a front cross-sectional view of a vaporizer cartridge, consistent with implementations of the current subject matter;

FIG. 13F illustrates a front cross-sectional view of a vaporizer cartridge, consistent with implementations of the current subject matter;

FIG. 14A illustrates a top perspective view of a vaporizer device, consistent with implementations of the current subject matter;

FIG. 14B illustrates a top perspective view of a vaporizer device, consistent with implementations of the current subject matter;

FIG. 14C illustrates a top perspective view of a vaporizer device, consistent with implementations of the current subject matter;

FIG. 15A illustrates a top perspective view of a vaporizer device, consistent with implementations of the current subject matter;

FIG. 15B illustrates a top perspective view of a vaporizer device, consistent with implementations of the current subject matter;

FIG. 15C illustrates a top perspective view of a vaporizer device, consistent with implementations of the current subject matter;

FIG. 16A illustrates an exemplary cross-section of a cartridge and/or receptacle of a vaporizer device, consistent with implementations of the current subject matter;

FIG. 16B illustrates an exemplary cross-section of a cartridge and/or receptacle of a vaporizer device, consistent with implementations of the current subject matter;

FIG. 16C illustrates an exemplary cross-section of a cartridge and/or receptacle of a vaporizer device, consistent with implementations of the current subject matter;

FIG. 16D illustrates an exemplary cross-section of a cartridge and/or receptacle of a vaporizer device, consistent with implementations of the current subject matter;

FIG. 16E illustrates an exemplary cross-section of a cartridge and/or receptacle of a vaporizer device, consistent with implementations of the current subject matter; and

FIG. 16F illustrates an exemplary cross-section of a cartridge and/or receptacle of a vaporizer device, consistent with implementations of the current subject matter.

When practical, similar reference numbers denote similar structures, features, or elements.

### DETAILED DESCRIPTION

Implementations of the current subject matter include methods, apparatuses, articles of manufacture, and systems relating to vaporization of one or more materials for inhalation by a user. For example, various implementations of vaporizer devices are described herein that provide a number of benefits, including improving contact between a heating element and/or heated surface of a heating system and a cartridge containing vaporizable material to ensure efficient and effective thermal transfer between the heating element and vaporizable material. For example, by maintaining intimate contact between the cartridge and the heating element and/or heated surface, thermal losses (e.g., to a surrounding housing of the vaporizer device) may be reduced, and heating efficiency (e.g., per amount of power consumption) may be increased. An additional benefit that may be provided by various implementations of vaporizer devices described herein is increased user satisfaction. For example, in some implementations, the proper mixing of relatively cool air (e.g., ambient temperature air) and heated air containing vaporized material can improve the formation of sub-micron sized aerosol particles, thereby reducing condensation of one or more compounds released during heating of the vaporized material onto internal surfaces (e.g., inhalation tubes and/or mouthpiece components) of the vaporizer. Such condensates may ultimately be drawn into the mouth of a user in liquid form, thereby leading to unpleasant taste sensations, and are not available for inhalation, thereby reducing an amount of available inhalable product. Accordingly, by ensuring proper mixing and aerosol generation, implementations of the current subject matter can increase user satisfaction.

In some implementations, the vaporizable material can be placed within a cartridge that is in direct contact with and/or in close proximity to a heating element of a heating system to allow for efficient and effective heat transfer from the heating element to the cartridge, and thereby to the vaporizable material. In some implementations, a cartridge comprising the vaporizable material, e.g., vaporizable material contained within an appropriately configured structure, can be placed within a vaporization chamber, heater chamber, oven, or the like, in which case the area or volume in the vaporizer device within which a heating element causes heating of at least a portion of a vaporizable material includes an internal area or volume of the cartridge. Characteristics of an appropriately configured structure may include one or more of being formed at least partially of metal or some other material that is durable under heating and that has a sufficient thermal conductivity, having one or more openings through which air may enter and/or exit the cartridge to aid in convective heating of the vaporizable material and/or conveyance of inhalable components generated by heating the vaporizable material out of the cartridge, and the like. In other implementations, the vaporizable material can be placed in direct contact with and/or in close proximity to a heating element of a heating system to allow for efficient and effective heat transfer from the heating element to the vaporizable material. As such, the vaporizer devices, heating systems, cartridges, and vaporizable material described herein can provide more efficient heating of vaporizable material and formation of inhalable aerosol compared to some currently available vaporizer devices. Other benefits are described herein and are within the scope of this disclosure.

The term “vaporizer device” as used in the following description and claims refers to any of a self-contained apparatus, an apparatus that includes two or more separable parts (e.g., a vaporizer body that includes a battery and other hardware, a cartridge and/or insert that includes a vaporizable material, and/or a mouthpiece configured to deliver an inhalable aerosol to a user), and/or the like. A “vaporizer system,” as used herein, can include one or more components, such as a vaporizer device, a charger for charging the vaporizer device, a wired or wireless communication device in communication with the vaporizer device, a remote server in communication with the communication device, and/or the like. Examples of vaporizer devices consistent with implementations of the current subject matter include electronic vaporizers, electronic nicotine delivery systems (ENDS), and/or the like. Such vaporizer devices can be hand-held devices that heat (such as by convection, conduction, radiation, and/or some combination thereof) a vaporizable material to provide an inhalable dose of the material to a user.

The vaporizable material used with a vaporizer device may optionally be provided within a cartridge (e.g., an insertable and removable part of the vaporizer device that contains the vaporizable material) which can be refillable when empty, or disposable such that a new cartridge containing additional vaporizable material of a same or different type can be used. A vaporizer device can be a cartridge-using vaporizer device, a cartridge-less vaporizer device, or a multi-use vaporizer device capable of use with or without a cartridge. Some cartridge implementations can include a vaporizable material, which can be packed to an appropriate density, as described herein. In some implementations, a vaporizer device can include a heating chamber or compartment (e.g., a receptacle) configured to receive a cartridge directly therein and heat the vaporizable material for forming an inhalable aerosol.

In some implementations, a vaporizer device can be configured for use with a liquid vaporizable material (for example, a carrier solution in which an active and/or inactive ingredient(s) are suspended or held in solution, or a liquid form of the vaporizable material itself) and/or a non-liquid vaporizable material (e.g., a paste, a wax, a gel, a solid, a plant material, and/or the like). A non-liquid vaporizable material can include a plant material that emits some part of the plant material as the vaporizable material (for example, some part of the plant material remains as waste after the material is vaporized for inhalation by a user) or optionally can be a solid form of the vaporizable material itself, such that all of the solid material can eventually be vaporized for inhalation. A liquid vaporizable material can likewise be capable of being completely vaporized, or can include some portion of the liquid material that remains after all of the material suitable for inhalation has been vaporized.

Implementations of vaporizable material can be at least partly made of a non-liquid vaporizable material, such as tobacco (e.g., leaves) and/or other plant substances. In some aspects, vaporizable material can also include a humectant or other aerosol forming material or carrier, such as propylene glycol, vegetable glycerin, and/or the like. As such, some implementations of the vaporizer device can be configured to use a vaporizable material that is at least partly made of one or more vaporizable materials (e.g., that includes one or more compounds that can be converted to the gas phase when the vaporizable material is heated to a sufficient temperature) for heating and forming an inhalable aerosol, as will be described in greater detail below.

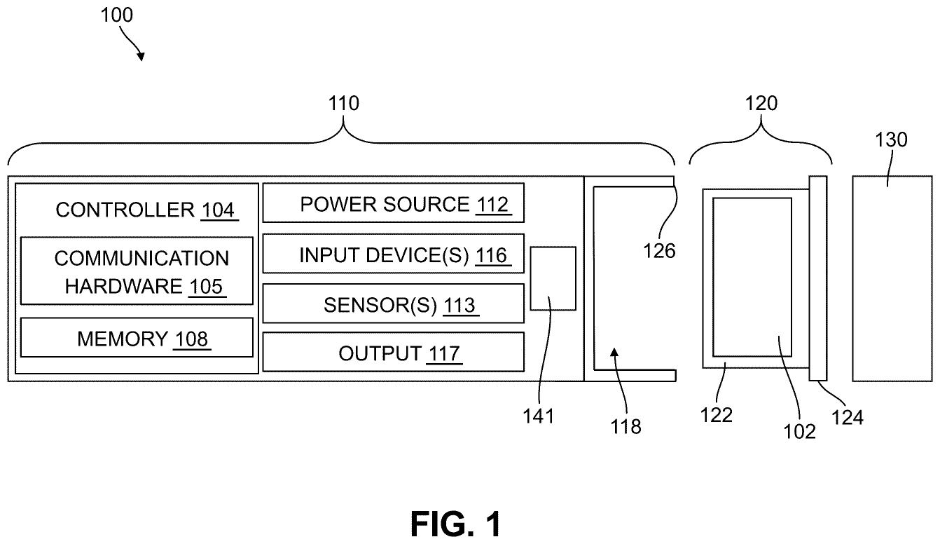

FIG. 1 depicts a block diagram illustrating an example of a vaporizer device 100 consistent with implementations of the current subject matter. Referring to FIG. 1, the vaporizer device 100 can include a power source 112 (for example, a battery, which can be a rechargeable battery), and a controller 104 (for example, a processor, circuitry, etc. capable of executing logic) for controlling delivery of heat from a heating element 141 to cause at least a portion of the vaporizable material 102 (such as a solid, a liquid, a solution, a suspension, a part of an at least partially unprocessed plant material, etc.) of a cartridge 120 to be converted to the gas-phase. The controller 104 can be part of one or more printed circuit boards (PCBs) consistent with certain implementations of the current subject matter.

After conversion of some amount of one or more compounds present in the vaporizable material 102 to the gas phase, at least some of those gas-phase compounds can condense to form particulate matter in at least a partial local equilibrium with the gas phase as part of an aerosol, which can form some or all of an inhalable dose provided by the vaporizer device 100 during a user's puff or draw on the vaporizer device 100. It should be appreciated that the interplay between gas and condensed phases in an aerosol generated by a vaporizer device 100 can be complex and dynamic, due to factors such as temperature (e.g., ambient or local at various points within the vaporizer device and/or cartridge, relative humidity, chemistry, vapor pressure of one or more vaporizable compounds, flow conditions in airflow paths (both inside the vaporizer device 100 and in the airways of a human or other animal), and/or mixing of the one or more compounds in the gas phase or in the aerosol phase with other air streams, which can affect one or more physical parameters of an aerosol. In some vaporizer devices, and particularly for vaporizer devices configured for delivery of very volatile compounds, the inhalable dose can exist predominantly in the gas phase (for example, formation of condensed phase particles can be very limited).

The heating element 141 can include one or more of a conductive heater, a radiative heater, and/or a convective heater. One type of heating element is a resistive heating element, which can include a material (such as a metal or alloy, for example a nickel-chromium alloy, or a non-metallic resistor) configured to dissipate electrical power in the form of heat when electrical current is passed through one or more resistive segments of the heating element. In some implementations of the current subject matter, the heating element 141 (e.g., a resistive heating element and/or the like) is configured to generate heat for converting to the gas phase one or more compounds present in the vaporizable material 102 to generate an inhalable dose of the one or more compounds present in the vaporizable material 102. As noted, the vaporizable material 102 may be a liquid or non-liquid (or combination of both liquid and non-liquid). For example, the heating element 141 may be wrapped around, pressed into thermal contact with, or otherwise arranged to deliver heat to the vaporizable material 102 to cause release of one or more compounds into the gas phase for subsequent inhalation by a user in a gas-phase and/or a condensed (for example, aerosol particles or droplets) phase. In some implementations, the heating element 141 may be wrapped around, pressed into thermal contact with, or otherwise arranged to deliver heat to the cartridge 120 containing the vaporizable material 102 to convert the one or more compounds from the vaporizable material to the gas phase.

In some implementations, the vaporizable material 102 may be a non-liquid vaporizable material including, for example, a solid-phase material (such as a gel, a wax, or the like) or plant material (e.g., tobacco leaves and/or parts of tobacco leaves). Where the vaporizable material 102 is a non-liquid vaporizable material, the heating element 141 can be part of, or otherwise incorporated into or in thermal contact with, the walls of a heating chamber or compartment (e.g., receptacle 118) into which the cartridge 120 and/or the vaporizable material 102 is placed. Additionally or alternatively, the heating element 141 can be used to heat air passing through or past the cartridge 120, to cause convective heating of the vaporizable material 102 (e.g., within the cartridge 120). In still other examples, the heating element 141 can be disposed in intimate contact with the vaporizable material 102 such that direct conductive heating of the vaporizable material 102 of the cartridge 120 occurs from within a mass of the vaporizable material 102, as opposed to only by conduction inward from walls of the heating chamber (e.g., an oven and/or the like). Convective heating of air passing through or past the cartridge may also occur in such configurations. In some implementations, the heating element 141 can be a part of the vaporizer body 110 (e.g., part of the durable or reusable part of the vaporizer 100), as shown in FIG. 1.

In some implementations, the heating element 141 can be a part of the cartridge 120 (e.g., part of the disposable part of the vaporizer 100). For example, the cartridge 120 can include one or more cartridge contacts that mate with one or more vaporizer body contacts (e.g., positioned along the receptacle 118) for providing an electrically conductive pathway between the power source 112 of the vaporizer body 110 and the heating element 141 of the cartridge 120.

In some implementations, the heating element 141 can provide heat to convert to the gas phase one or more compounds present in the vaporizable material 102 in association with a user puffing (e.g., drawing, inhaling, etc.) on a mouthpiece 130 and/or end of the vaporizer device 100 to cause air to flow from an air inlet, along an airflow path for assisting with forming an aerosol that can be delivered out through an air outlet in the mouthpiece 130 and inhaled by a user. Incoming air moving along the airflow path moves past (e.g., around, past, over, etc.) or through the cartridge 120 and/or vaporizable material 102 where compounds released from the vaporizable material 102 into the gas-phase are entrained into the air. The heating element 141 can be activated via the controller 104, which can optionally be a part of the vaporizer body 110 as discussed herein, causing current to pass from the power source 112 through a circuit including the heating element 141, which can be part of the vaporizer body 110. As noted herein, at least some of the entrained one or more gas-phase compounds can condense while passing through the remainder of the airflow path such that an inhalable dose of the one or more compounds in an aerosol form can be delivered from the air outlet (e.g., via the mouthpiece 130) for inhalation by a user.

In some implementations, the heating element 141 can be activated in association with a user interacting with the vaporizer device 100. For example, activation of the heating element 141 can be caused by automatic detection of a puff or other user interaction based on one or more signals generated by one or more sensors 113. The one or more sensors 113 and/or the signals generated by the one or more sensors 113 can include one or more of: a pressure sensor or sensors disposed to detect pressure along the airflow path of the vaporizer device 100 relative to ambient pressure or optionally to measure changes in absolute pressure; a temperature sensor or sensors, such as a thermistor, a thermocouple, or the like disposed to measure the temperature of the receptacle 118 or some other component of the vaporizer device or the cartridge itself; one or more circuits configured to determine a temperature of the heating element 141, for example by measuring or determining a resistance of the heating element 141; a motion sensor or sensors, such as an accelerometer, a gyroscope, or the like, configured to detect movement, vibration, orientation, position, acceleration, etc. of the vaporizer device 100; a flow sensor or sensors configured to detect a flow rate of air, gas, or liquid within the vaporizer device 100; a capacitive sensor configured to detect touch, such as of a user's finger(s), palm(s), lip(s)), etc. on some part of the vaporizer device 100; detection of interaction with the vaporizer device 100 via one or more input devices 116, such as buttons, other tactile control devices, or the like of the vaporizer device 100; receipt of signals from a computing device in communication with the vaporizer device 100; and/or via other approaches for determining that a puff is occurring or imminent.

In some implementations, the vaporizer device 100 can be configured to start a heating cycle that can include a period of heating the heating element 141, receptacle 118, cartridge 120, and/or vaporizable material 102 to an operating (e.g., pre-determined) temperature or temperature range (e.g., a temperature or range sufficient to convert to the gas phase one or more compounds present in the vaporizable material 102). Once the heating element 141, receptacle 118, cartridge 120, and/or vaporizable material 102 reach the operating temperature or temperature range, the vaporizer device 100 can be configured to maintain or otherwise regulate the application of heat such that the vaporizable material 102 can be vaporized without burning. In some implementations, additional heat can be provided via the heating element 141 upon detection of an event, such as a user placing their lips on the vaporizer device 100, the user taking a puff on the vaporizer device 100, and/or any of the signals (e.g., generated by the one or more sensors 113) described herein. The heating cycle can terminate upon detection of an additional interaction with the vaporizer device 100 via the one or more input devices 116, upon determining that a certain amount of time has elapsed since the start of the heating cycle, upon determining that a certain amount of time has elapsed since the last detection of a user puff, upon determining that a cartridge 120 is not present within the receptacle 118, as a result of other events, actions, detected durations of the same, etc. consistent with implementations described herein.

As discussed herein, the vaporizer device 100 consistent with implementations of the current subject matter can be configured to connect (e.g., wirelessly or via a wired connection) to a computing device (or optionally two or more devices) in communication with the vaporizer device 100. To this end, the controller 104 can include communication hardware 105. The controller 104 can also include a memory 108. The communication hardware 105 can include firmware and/or can be controlled by software for executing one or more protocols for the communication.

A computing device can be a component of a vaporizer system that also includes the vaporizer device 100, and can include its own hardware for communication, which can establish a wireless communication channel with the communication hardware 105 of the vaporizer device 100. For example, a computing device used as part of a vaporizer system can include a general-purpose computing device (such as a smartphone, a tablet, a personal computer, some other portable device such as a smartwatch, or the like) that executes software to produce a user interface for enabling a user to interact with the vaporizer device 100. In other implementations of the current subject matter, such a device used as part of a vaporizer system can be a dedicated piece of hardware such as a remote control or other wireless or wired device having one or more physical or soft (e.g., configurable on a screen or other display device and selectable via user interaction with a touch-sensitive screen or some other input device 116 like a mouse, pointer, trackball, cursor buttons, or the like) interface controls. The vaporizer device 100 can also include one or more outputs 117 or devices for providing information to the user. For example, the outputs 117 can include one or more light emitting diodes (LEDs) configured to provide feedback to a user based on a status and/or mode of operation of the vaporizer device 100. The one or more LEDs can be single-color LEDs and/or multicolored LEDs (e.g., both may be separately used).

In the example in which a computing device provides signals related to activation of the heating element 141, or in other examples of coupling of a computing device with the vaporizer device 100 for implementation of various control or other functions, the computing device executes one or more computer instruction sets to provide a user interface and underlying data handling. In one example, detection by the computing device of user interaction with one or more user interface elements can cause the computing device to signal the vaporizer device 100 to activate the heating element to reach an operating temperature for creation of an inhalable dose of aerosol. Other functions of the vaporizer device 100 can be controlled by interaction of a user with a user interface on a computing device in communication with the vaporizer device 100.

The temperature of the heating element 141 of the vaporizer device 100 can depend on a number of factors, including an amount of electrical power delivered to the heating element 141 and/or a duty cycle at which the electrical power is delivered, conductive and/or radiative heat transfer to other parts of the vaporizer device 100 and/or to the environment, latent heat losses due to vaporization of the vaporizable material 102, and/or convective heat losses due to airflow (e.g., air moving across the heating element 141 and/or an area heated by the heating element 141 when a user puffs on the vaporizer device 100). As noted herein, to reliably activate the heating element 141 and/or heat the heating element 141 to a desired temperature, the vaporizer device 100 may, in some implementations of the current subject matter, make use of signals from the one or more sensors 113 (for example, a pressure sensor) to determine when a user is inhaling. The one or more sensors 113 can optionally be positioned in the airflow path and/or can be connected (for example, by a passageway or other path) to an airflow path containing an inlet for air to enter the vaporizer device 100 and an outlet via which the user inhales the resulting aerosol such that the one or more sensors 113 experiences changes (for example, pressure changes) concurrently with air passing through the vaporizer device 100 from the air inlet to the air outlet. In some implementations of the current subject matter, the heating element 141 can be activated in association with a user's puff, for example by automatic detection of the puff, or by the one or more sensors 113 detecting a change (such as a pressure change) in the airflow path.

The one or more sensors 113 can be positioned on or coupled to (e.g., electrically or electronically connected, physically or via a wireless connection) the controller 104 (for example, a printed circuit board assembly or other type of circuit board). To take measurements accurately and maintain durability of the vaporizer device 100, it can be beneficial to provide a seal resilient enough to separate an airflow path from other parts of the vaporizer device 100. The seal, which can be a gasket, can be configured to at least partially surround the one or more sensors 113 such that connections of the one or more sensors 113 to the internal circuitry of the vaporizer device 100 are separated from a part of the one or more sensors 113 exposed to the airflow path. Such arrangements of the seal in the vaporizer device 100 can be helpful in mitigating against potentially disruptive impacts on vaporizer components resulting from interactions with environmental factors such as water in the vapor or liquid phases and/or to reduce the escape of air from the designated airflow path in the vaporizer device 100. Passage of air, liquid, or other fluid passing and/or contacting circuitry of the vaporizer device 100 can cause various unwanted effects, such as altered pressure readings, and/or can result in the buildup of material, such as moisture or residue, errant portions of the vaporizable material 102, etc., in parts of the vaporizer device 100 where they can result in poor pressure signal, degradation of the one or more sensors 113 or other components, and/or a shorter life of the vaporizer device 100. Leaks in the seal can also result in a user inhaling air that has passed over parts of the vaporizer device 100 containing, or constructed of, materials that may not be desirable to be inhaled.

In vaporizer devices in which the power source 112 is part of a vaporizer body 110 and the heating element 141 is disposed in the cartridge 120 configured to couple with the vaporizer body 110, the cartridge 120 and vaporizer 100 may include electrical connection features (e.g., electrical contacts) for completing a circuit that includes the controller 104 (e.g., a printed circuit board, a microcontroller, or the like), the power source 112, and the heating element 141. The circuit completed by these electrical connections can allow delivery of electrical current to the heating element 141 (e.g., resistive heating element) and may further be used for additional functions, such as measuring a resistance of the resistive heating element for use in determining and/or controlling a temperature of the resistive heating element based on a thermal coefficient of resistivity of the resistive heating element.

In some implementations, the receptacle 118 can include all or part of the heating element 141 (e.g., a heating coil, resistive heating element, etc.) that is configured to heat the cartridge 120 received in the receptacle 118, such as for forming an aerosol to be inhaled by a user of the vaporizer device 100. For example, the receptacle 118 can include various implementations of the heating element 141 that are configured to receive and/or be placed in contact with the cartridge 120. Various implementations of the heating element 141, the receptacle 118, and the cartridge 120 are described herein for integration within and/or use with a variety of vaporizer bodies 110 for forming inhalable aerosol.

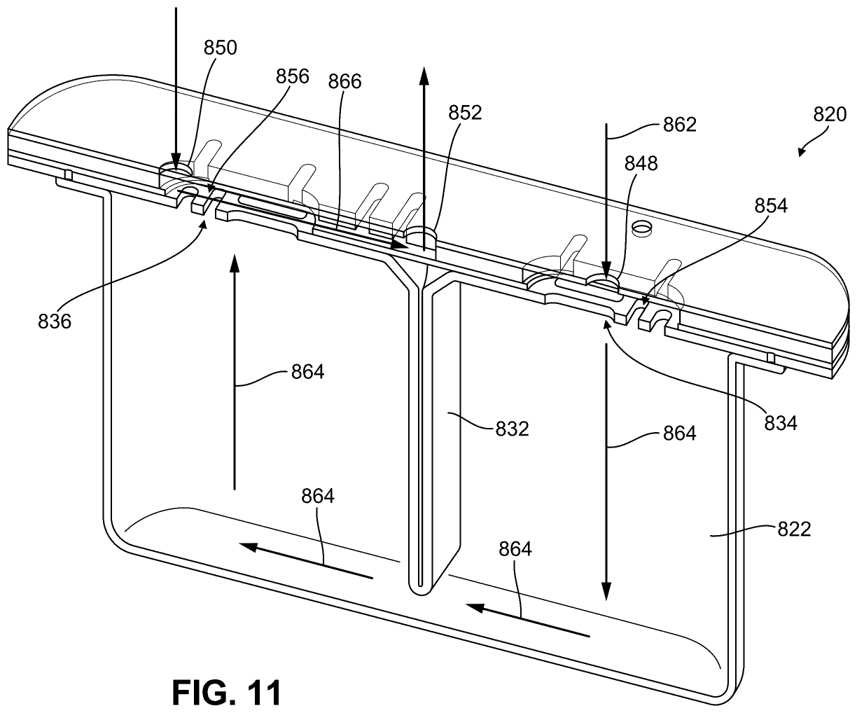

In some implementations, the cartridge 120 can be configured for insertion in the receptacle 118, such as for forming contact between an outer surface of the cartridge 120 and one or more inner walls of the receptacle 118. In some implementations, the cartridge 120 can have a same or a similar shape as the receptacle 118. In some implementations, the cartridge 120 can include a square or rectangular shape. In some implementations, the cartridge 120 can include a circular cross-section and/or a cylindrical shape. In some implementations, the cartridge 120 can have a non-circular cross section transverse to the axis along which the cartridge 120 is inserted into the receptacle 118. The non-circular cross section(s) of the cartridge 120 and/or receptacle 118 can include two sets of parallel or approximately parallel opposing sides (e.g., having a parallelogram-like shape), or other shapes, including curved shapes, having rotational symmetry of at least order two. For example, FIGS. 11A-11F illustrate example cross-sections of the cartridge 120 and/or receptacle 118, including a rectangular shape (FIG. 11A), a rounded rectangular shape (FIG. 11B), an elliptical or oval shape (FIG. 11C), or other shapes that include corners, bends, edges, protrusions, recesses, and/or the like (FIGS. 11D-11F). In this context, approximate shape indicates that a basic likeness to the described shape is apparent, but that sides of the shape in question need not be completely linear and vertices need not be completely sharp. Rounding of both or either of the edges or the vertices of the cross-sectional shape is contemplated in the description of any non-circular cross section referred to herein.

In some implementations, at least one of the one or more inner walls forming the receptacle 118 can include the heating element 141 and/or include thermally conductive material. For example, cartridge 120 configurations in which the cartridge 120 forms a sliding fit and/or forms close contact with the receptacle 118 can allow for efficient heat transfer between the heating element 141, the receptacle 118, and the cartridge 120, thereby causing efficient and effective heating of the vaporizable material 102 of the cartridge 120.

Furthermore, the cartridge 120 can include compressed and/or higher density configurations of non-liquid vaporizable material 102, which can further contribute to efficient and effective heating and converting to the gas phase one or more compounds present in the vaporizable material 102. For example, vaporizable material 102 in a compressed and/or high-density configuration can include a minimal amount of air or pockets of air in the vaporizable material 102 thereby increasing the efficiency and effectiveness of transferring heat within the vaporizable material 102. Such a configuration can allow for reduced power consumption at least because less heating power is needed to effectively heat the vaporizable material 102 to a temperature sufficient to cause release of inhalable substances. Additionally, lower temperatures (e.g., at a contact surface of an oven or heating element) can be used to heat the vaporizable material 102 at least because of the improved heating efficiency of the vaporizable material 102, which can also reduce power consumption and formation of hazardous byproducts resulting from heating the vaporizable material at higher temperatures. Various implementations of the cartridge 120 are described herein that include the vaporizable material formed in compressed and/or high-density configurations for achieving at least some of the benefits described above.

In some implementations, the vaporizer device 100 can include a heating system configured to receive and heat the vaporizable material 102 for generating an inhalable aerosol. For example, implementations of the heating system can include one or more heating elements 141 positioned at, against, near, within, outside, and/or along the walls of the receptacle 118 (e.g., extending along at least a portion of the wall(s) at the distal end (e.g., bottom) of the receptacle 118, extending along at least a portion of each of the distal wall(s) and/or side wall(s) of the receptacle 118, etc.). In some implementations, the one or more heating elements 141 can be configured to heat one or more of the walls of the receptacle 118 from the outside to the interior of the receptacle 118 (e.g., with the vaporizable material 102 being in the interior of the receptacle 118). The heating system can also include at least one airflow pathway, which can be configured to move heated air through the vaporizable material 102. As will be described in greater detail below, the heating system can be configured to receive the cartridge 120 and heat the cartridge 120 from the outside-in (e.g., from an outer surface to an interior of the cartridge 120 (e.g., the interior being where vaporizable material 102 is housed)) using at least one heating element 141 to provide an inhalable aerosol via one or more airflow pathways for inhalation by a user.

Various implementations of such heating systems of vaporizer devices 100 are described herein that provide a number of benefits, including evenly distributing heat through the vaporizable material 102 of the cartridge 120. This can result in improved inhalable aerosol generation, less energy and/or lower average temperatures required to form inhalable aerosol, and increased user satisfaction with the device use and consumption of the vaporizable material 102.

In some implementations, the heating system of the vaporizer device 100 is configured to heat a non-liquid vaporizable material, such as a tobacco-based material. For example, the vaporizer body 110 can include one or more compartments or receptacles 118 that each accept at least one cartridge 120 configured to be heated by one or more heating elements 141 thereby generating an inhalable aerosol. In some implementations, the vaporizer device 100 may include one or more airflow pathways that extend through the cartridge 120 positioned within a respective receptacle 118, and out through a mouthpiece 130 to a user.

In some implementations, the cartridge 120 may include a non-vapor permeable barrier (e.g., metal, metal alloy, paper material such as cardstock, corrugated material such as cardboard, tobacco paper, temperature-resistant plastic, and/or the like) configured to contain vaporizable material 102. In some implementations, use of a metal such as aluminum may be advantageous where efficient heat transfer (e.g., requiring less energy to spread across a larger region) is required, which can be the case where a singular heat source is provided. In other implementations, a metal such as stainless steel may be advantageous where efficient heat transfer is of less concern, such as where multiple heat sources are provided to heat different regions of the cartridge 120. Containing the vaporizable material 102 within a non-vapor permeable barrier can protect the heating element 141, receptacle 118, mouthpiece 130 and/or other portions of the vaporizer device 100 from vapor deposits and/or remains of the vaporizable material, such that cleaning of the heating element 141 and/or other portions of the vaporizer device 100 after use may not be required.

As illustrated, the cartridge 120 can include a container 122 and a lid 124. In some aspects, the container 122 can be configured to hold the vaporizable material 102 and/or the lid 124 can be configured to close the top (e.g., proximal end) of the container 122 such that the vaporizable material 102 remains within the container 122. In some implementations, the lid 124 and/or a proximal end of the container 122 can extend beyond the general width of the container 122 (e.g., the width at the distal end of the container 122 and/or the width of the container 122 at a midpoint of the container 122 between the proximal and distal ends), such that a portion of the cartridge 120 rests outside of the receptacle 118. Stated another way, the width of the cartridge 120 can taper in from the lid 124 and/or proximal end of the cartridge 120 such that a portion of the cartridge 120 rests on a ledge 126 outside of the receptacle 118 and another portion of the cartridge 120 (e.g., the more than half of the container 122 and/or more than half of the vaporizable material 102) rests within the receptacle 118. Various implementations of a heating system and cartridge 120 are described in greater detail below.

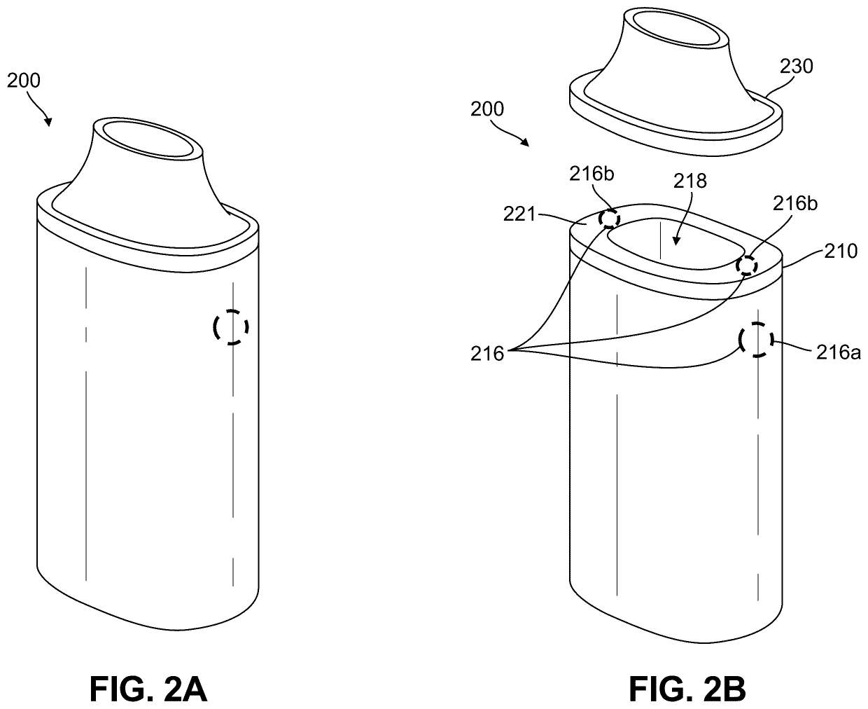

FIGS. 2A-B illustrate perspective views of an implementation of a vaporizer device 200, consistent with implementations of the current subject matter. The vaporizer device 200 can be an implementation of one or more components of the vaporizer device 100 of FIG. 1. For example, as illustrated, the vaporizer device 200 can include a vaporizer body 210 and a mouthpiece 230. When the mouthpiece 230 is removed from the vaporizer body 210, a receptacle 218 is exposed. Outside of the receptacle 218, the vaporizer body includes a ledge 221. As described herein, a cartridge containing vaporizable material can be inserted into the receptacle 218, and at least a portion of the cartridge can remain outside of the receptacle 218, such as by resting on the ledge 221. The mouthpiece 230 can be attached to the vaporizer body 210 in a closed position, in which case the cartridge can be enclosed within the vaporizer device 200 and/or at least partially enclosed within the receptacle 218.

In some implementations, the mouthpiece 230 can be completely removable and attachable to the vaporizer body 210 by one or more coupling mechanisms, such as snap fit, magnetic force, and/or the like. In some implementations, the mouthpiece 230 can be attached to the vaporizer body 210 by a hinge, ball-and-socket, clasp, and/or the like.

As illustrated, the vaporizer device 200 can include one or more input devices 216a, 216b (collectively referred to as input devices 216), such as a pair of input devices 216a on opposing sides of the vaporizer body 210 and/or one or more input devices 216b on the ledge 221, such that the one or more input devices 216b are accessible to a user only when the mouthpiece 230 is opened and/or removed to expose the receptacle 218. In some implementations, the one or more input devices 216a, 216b can include a button (e.g., plastic, metal, elastomeric), a capacitive sensor, and/or the like. A controller 104 (not illustrated) of the vaporizer device 200 can be configured to detect actuation (e.g., touch or force) of the one or more input devices 216a, 216b based on signals or data provided by the one or more input devices 216a, 216b. In implementations where multiple input devices 216a are present, a controller 104 of the vaporizer device 200 can be configured to activate the device only in response to detecting actuation of all of the input devices 216a. It can be beneficial to provide multiple input devices 216a in different locations that are less likely to each be activated accidentally (e.g., in locations most likely to be touched all at the same time only during active use of the vaporizer device 200).

In some implementations, the controller 104 can be configured to select predetermined operating temperatures and/or heating profiles from among N temperatures or profiles. In accordance with these implementations, the controller 104 can be configured (and thereby a user can be allowed) to select a temperature or profile based on detecting actuation of the one or more input devices 216b. In some implementations, two or more input devices 216b can be used to increase and decrease the currently selected operating temperature and/or profile between a range of zero (0) through N temperatures and/or profiles, where zero means the vaporizer device 200 is in an “off” state (e.g., not actively heating the receptacle 218 but otherwise configured to detect interactions with one or more components of the vaporizer device 200). Accordingly, one of the two or more input devices 216b can be actuated to increase the currently selected operating temperature and/or profile and another of the two or more input devices 216b can actuated to decrease the currently selected operating temperature and/or profile. The two or more input devices 216b can be actuated to provide for switching between the “off” state and an “on” state (e.g., where the “on” state starts at the lowest pre-configured temperature and/or profile) when both of the two or more input devices 216b or a dedicated one of the two or more input devices 216b are/is actuated (e.g., held down or pressed) for a predetermined time. In other implementations, one input device 216b can be actuated to increase the temperature and/or profile through a range of zero (0) through N temperatures and/or profiles, and/or the one input device 216b can be held down to switch between the “off” state and the “on” state.

In some implementations, the controller 104 can be configured to detect when the mouthpiece 230 is being pushed with sufficient force against the vaporizer body 210 (e.g., against the ledge 221) and/or for a sufficient duration of time. In response to determining that the mouthpiece 230 is being pushed with sufficient force and/or for a sufficient duration of time, the controller 104 can switch the vaporizer device 200 between the “off” state and the “on” state (e.g., when the mouthpiece is held down for a predetermined time), increase the temperature and/or profile through a range of zero (0) through N temperatures and/or profiles, and/or the like.

In some implementations, the controller 104 can be configured to determine whether a cartridge 120 is spent and/or should be changed. This can occur when all, most, or an estimated threshold amount of one or more compound present in the vaporizable material 102 contained within the cartridge 120 has been converted to the gas phase, when an insufficient amount or quality of the vaporizable material 102 is present to provide an inhalable aerosol that would be satisfying to a user, and/or the like. For example, based on the length of time the cartridge 120 is heated, the temperatures at which the cartridge 120 is heated across the length of time, and/or the like, the controller 104 can be configured to determine that the cartridge is spent and/or should be changed. Based on determining that the cartridge is spent and/or should be changed, the controller 104 can be figured to provide an indication that the cartridge is spent and/or should be changed, switch the vaporizer device 200 into the “off” state, and/or the like. During operation of the vaporizer device 200, the controller 104 can be configured to provide indications of an estimated amount of vaporizable material 102 left in the cartridge and/or an estimated amount of time remaining in a vaporizing session during which the vaporizable material 102 may be used (e.g., a period of time starting when the vaporizer device 200 is heated or when the receptacle 218 reaches a predetermined operating temperature and ending when the cartridge 120 is spent and/or should be changed).

The vaporizer device 200 can include one or more LEDs and can be configured to illuminate the LEDs in response to detecting actuation of one or more of the input devices 216a, 216b, in response to detecting the mouthpiece 230 being pushed with sufficient force against the vaporizer body 210, to indicate the currently selected operating temperature and/or temperature profile, to indicate the current temperature of the receptacle 218, to indicate the current temperature of the receptacle 218 relative to the currently selected operating temperature and/or temperature profile, to indicate the current temperature of the receptacle 218 has reached the currently selected operating temperature, an estimated amount of useable vaporizable material 102 remaining in a cartridge 120, an estimated amount of time remaining in a vaporizing session, an indication that the cartridge 120 is spent and/or should be changed, and/or the like. In some implementations, the one or more input devices 216a, 216b can include the LEDs, be at least partially surrounded by the LEDs, and/or be positioned relative to the LEDs such that a perimeter (e.g., halo) of light at least partially surrounds a perimeter of the one or more input devices 216a, 216b.

The controller 104 can be configured to illuminate the LEDs in one or more colors and/or according to one or more patterns. For example, the controller 104 can be configured to illuminate the LEDs according to different colors to indicate a current temperature of the receptacle 218 (e.g., oven), blink one or more times to indicate the current temperature of the receptacle 218 has reached the currently selected operating temperature, and/or the like. Additionally or alternatively, the controller 104 can be configured to provide haptic feedback (e.g., via one or more outputs 117, such as a motor, a linear resonant actuator, and/or the like) to indicate the one or more input devices 216a, 216b have been pressed, whether the vaporizer device 200 has switched between the “off” state and the “on” state (e.g., that the receptacle 218 is heating up), a current temperature of the receptacle 218 (e.g., in a periodic pattern with increasing frequency), whether the current temperature of the receptacle 218 has reached the currently selected operating temperature, when threshold amounts of the estimated amount of useable vaporizable material 102 remaining in a cartridge 120 are reached, when threshold amounts of estimated amounts of time remaining in the vaporizing session are reached, that the cartridge 120 is spent and/or should be changed, and/or the like.

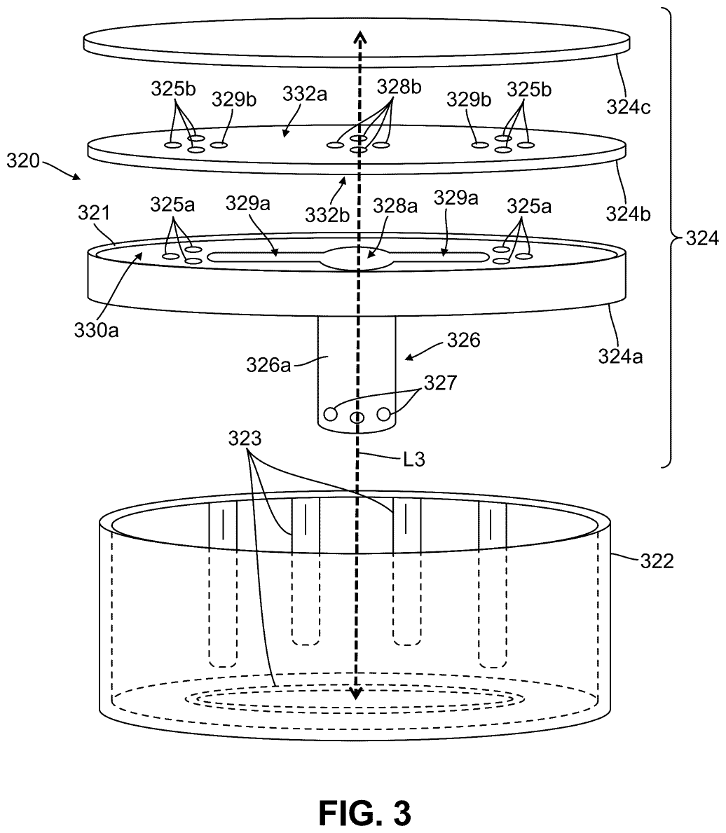

FIG. 3 illustrates an exploded front view of an implementation of a cartridge 320, consistent with implementations of the current subject matter. The cartridge 320 can be an implementation of one or more components of the cartridge 120 of FIG. 1, configured to hold a vaporizable material 102, and/or configured for use within a vaporizer device such as the vaporizer device 100 of FIG. 1 and/or the vaporizer device 200 of FIGS. 2A-B. As illustrated, the cartridge 320 can contain two or more components, such as a container 322 and a lid 324. The lid 324 can include one or more different components, such as a base component 324a, perforated lid 324b, and top barrier 324c.

As illustrated, the base component 324a can include a shaft 326, a plurality of through-holes 325a, one or more channels 329a, and/or a central opening 328a. The plurality of through-holes 325a can be in fluid communication with the container 322. As such, the plurality of through-holes 325a can be configured to deliver air to or towards the container 322 and/or withdraw air from the container 322. The one or more channels 329a can be in fluid communication with the central opening 328a. As such, the one or more channels 329a can be configured to deliver air to or towards the central opening 328a and/or withdraw air from the central opening 328a. The central opening 328a can be in fluid communication with the shaft 326. As such, the central opening 328a can be configured to deliver air to or towards the shaft 326 and/or withdraw air from the shaft 326. Although the central opening 328a is illustrated and described as being central to the base component 324a, in some implementations, the central opening 328a can be off-center (e.g., simply and “opening” that provides the same or similar functionality). Although only one central opening 328a is illustrated and described, in some implementations, more than one central opening 328a may be present, which may be “centralized” across one, two, three, or even no dimensions of the base component 324a.

While the shaft 326 can have a variety of configurations, as shown, the shaft 326 can have a generally cylindrical configuration and can include one or more shaft through-holes 327 extending through the wall(s) 326a of the shaft 326. The one or more shaft through-holes 327 can be in fluid communication with an interior channel (obstructed in FIG. 3) of shaft 326. As such, the one or more shaft through-holes 327 can be configured to deliver air to and/or withdraw air from the interior channel of shaft 326. Additionally or alternatively, the one or more shaft through-holes 327 can be in fluid communication with the container 322. As such, the one or more shaft through-holes 327 can be configured to deliver air to and/or withdraw air from the container 322.

Although illustrated as being positioned towards the distal end of the shaft 326, the one or more shaft through-holes 327 can be provided in a different location of the shaft 326, such as closer to the proximal end of the cartridge 320. Although three one or more shaft through-holes 327 are illustrated, one, two, or greater than three one or more shaft through-holes 327 may be present, positioned in a location that is closer to the proximal end of the cartridge 320, or both. In some implementations, at least one of the one or more shaft through-holes 327 can be present on the distal end of the shaft 326, and/or the distal end of the shaft 326 can be closed. While the illustrated one or more shaft through-holes 327 extend in a lateral direction relative to the longitudinal axis L of the shaft 326, in other implementations, the one or more shaft through-holes 327 may extend in a direction along or at an angle that is greater than or less than 90 degrees relative to the longitudinal axis L of the shaft. If the one or more shaft through-holes 327 extend along or at an angle that is greater than or less than 90 degrees relative to the longitudinal axis L of the shaft 326, then they may be efficiently provided within the shaft 326 via a stamping operation during the manufacturing process. In some implementations, the base component 324a can comprise metal, metal alloy, paper material such as cardstock, corrugated material such as cardboard, tobacco paper, temperature-resistant plastic, and/or the like.

As illustrated, the perforated lid 324b can include a plurality of through-holes 325b, one or more entrance holes 329b, and/or one or more exit holes 328b. The plurality of through-holes 325b of the perforated lid 324b can be configured to align with one or more of the plurality of through-holes 325a of the base component 324a and/or be in fluid communication with the plurality of through-holes 325a of the base component 324a. As such, the plurality of through-holes 325b of the perforated lid 324b can be configured to deliver air to or towards the plurality of through-holes 325a of the base component 324a and/or withdraw air from the plurality of through-holes 325a of the base component 324a.

The one or more entrance holes 329b can be configured to align with one or more of the one or more channels 329a of the base component 324a and/or be in fluid communication with the one or more channels 329a of the base component 324a. As such, the one or more entrance holes 329b of the perforated lid 324b can be configured to deliver air to or towards the one or more channels 329a of the base component 324a and/or withdraw air from the one or more channels 329a of the base component 324a. The one or more exit holes 328b can be configured to align with the central opening 328a of the base component 324a and/or be in fluid communication with the central opening 328a of the base component 324a. As such, the one or more exit holes 328b of the perforated lid 324b can be configured to deliver air to or towards the central opening 328a of the base component 324a and/or withdraw air from the central opening 328a of the base component 324a. Although the one or more entrance holes 329b and one or more exit holes 328b are described with respect to one direction of airflow, in some implementations, the one or more entrance holes 329b may be configured to allow air to exit (e.g., the one or more channels 329a) and/or the one or more exit holes 328b may be configured to allow air to enter (e.g., the central opening 328a).

In some implementations, the base component 324a and the perforated lid 324b can be coupled together. For example, the base component 324a can include a lip 321 that is configured to secure and press the distal side 332b of the perforated lid 324b against the proximal side 330a of the base component 324a. In some implementations, the lip 321 can be configured to rest above the perforated lid 324b (e.g., by bending and/or folding) to secure the perforated lid 324b against the proximal side 330a of the base component 324a.

In some implementations, the top barrier 324c may simply be removable and/or disposable. However, in some implementations, the top barrier 324c may remain secured to at least a portion of the proximal side 332a of the perforated lid 324b during use, in which case it can be configured and/or disposed to direct air towards the through-holes 325a, 325b, central opening 328a, one or more channels 329a, entrance holes 329b, and/or exit holes 328b. In accordance with these implementations, the top barrier 324c may include at least one hole such that inhalable aerosol exiting the cartridge 320 can be delivered to a user. In some implementations, the top barrier 324c and perforated lid can define a compartment therebetween. In such instances, during use, one or more compounds converted to the gas phase by heating of the vaporizable material and air present within the compartment can mix to form an inhalable aerosol to be inhaled by a user.

The container 322 can include a plurality of channels 323. The plurality of channels 323 can protrude from and/or extend into the interior of the container 322. In some implementations, the plurality of channels 323 can help to form the bulk shape of the vaporizable material 102 (not illustrated) within the container 322, which can affect the temperature at which the vaporizable material 102 is heated and/or the rate at which one or more compounds present in the vaporizable material 102 are converted to the gas phase and/or otherwise released from the vaporizable material 102. That is, when the vaporizable material is inserted into the container the bulk shape can be similar to the shape of the container, based at least in part on the vaporizable material filling the voids defined in the container. For example, if the plurality of channels 323 extend outward from the interior of the container 322, then the channels 323 may be in contact (e.g., physical and/or thermal) with one or more heated walls of the vaporizer device 100 (e.g., oven) and/or other regions of the exterior of the container 322 may not be contact with the one or more heated walls. In some aspects, reducing the total surface area of the container 322 that is intended to be in contact with one or more heated walls can reduce the effects, on aerosol generation, of heating variability (e.g., rapid increases or decreases in temperature of the heating element 141), degradation (e.g., warping or bowing), and/or cleanliness (e.g., foreign objects or residue) associated with the one or more heated walls over time. For example, implementing channels 323 that form controlled regions of thermal contact between the container 322 and the receptacle 118 reduces the total surface contact area of the container 322, and therefore may improve the predictability of heat transfer and reduce temperature variations between different cartridges 120 and/or different vaporizer devices 100 having slightly different dimensions. Accordingly, the plurality of channels 323 can provide controlled regions of close thermal contact between the container 322 and a heat source (e.g., the walls of an oven). In some implementations, the channels 323 may be configured to compress when the cartridge 322 is inserted into a heat source, which can increase the surface area of the container 322 in contact with heat from the heat source, at least in regions proximate to the channels 323. In some implementations, the plurality of channels 323 may not be filled by vaporizable material 102 (e.g., hollow or vacant), in which case the plurality of channels 323 can be configured to increase the circulation of (heated) air within the container 322. In some implementations, the plurality of channels 323 can provide the container 322 (and thereby the cartridge 320) with additional rigidity, such that the cartridge 320 is more resistant to a force that may otherwise crush the cartridge 320. Further, the plurality of channels 323 can minimize toggling between the cartridge 322 and the vaporizer body (not shown).

Although illustrated as generally cylindrical, a cross-section of the base component 324a, perforated lid 324b, and/or top barrier 324c can be a different shape. For example, in some implementations, a cross-section of the base component 324a, perforated lid 324b, and/or top barrier 324c can be similar to one or more of the cross-sections of FIGS. 11A-11F. The cross-section may be anywhere between the respective distal and proximal ends of each of the base component 324a, perforated lid 324b, and/or top barrier 324c.

Although the flow of “air” is described, depending on the location within or even outside of the cartridge 320, the “air” can contain other matter, such as gas-phase and/or condensed-phase material suspended in a stationary or moving mass of air or some other gas carrier (e.g., an aerosol), a liquid or solid at least partially transitioned to the gas phase (e.g., a vaporizable material), and/or the like.

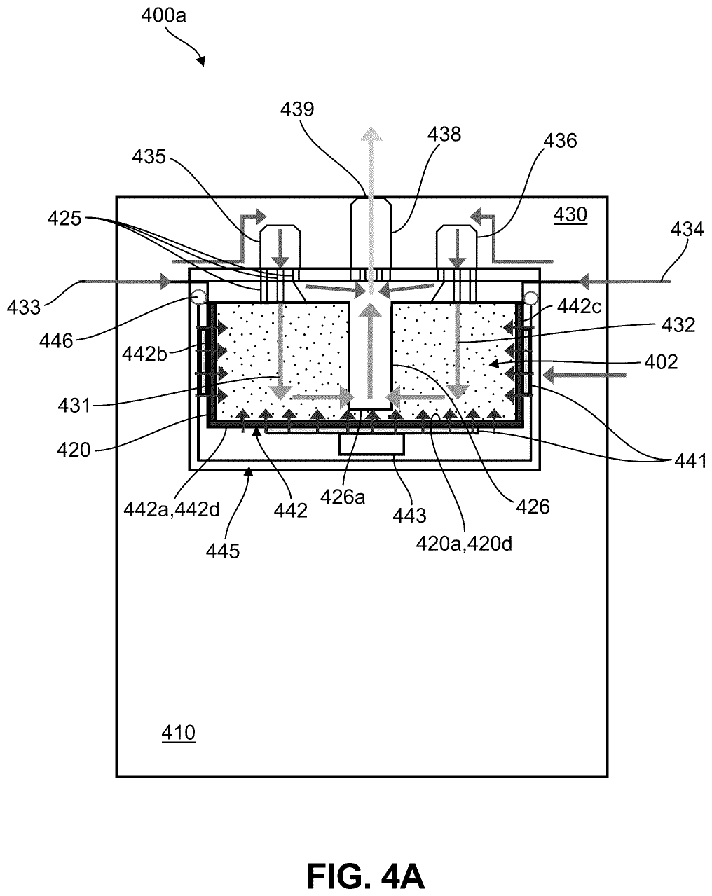

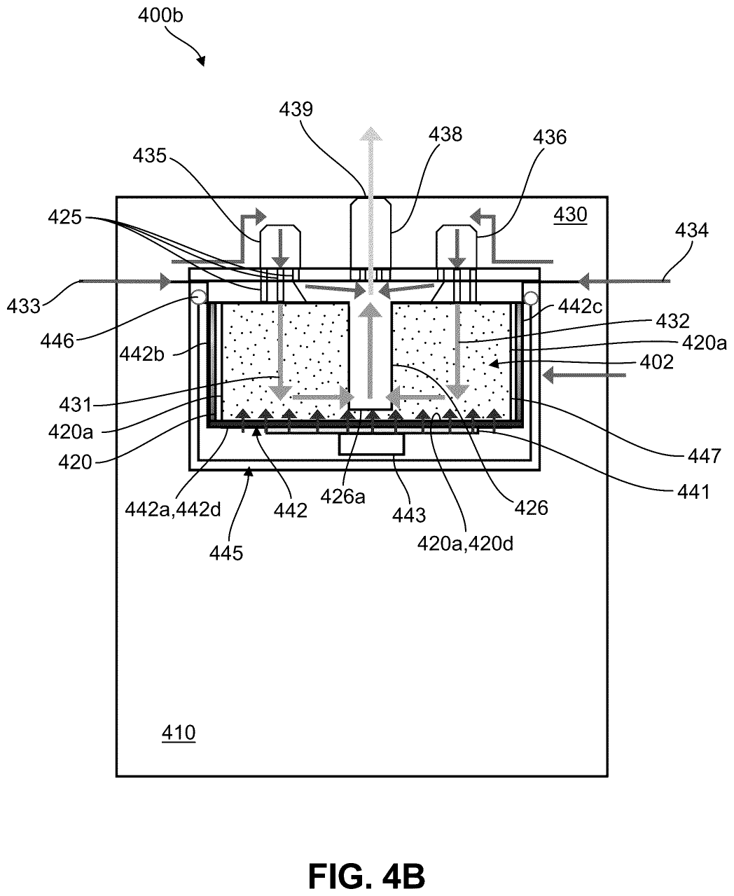

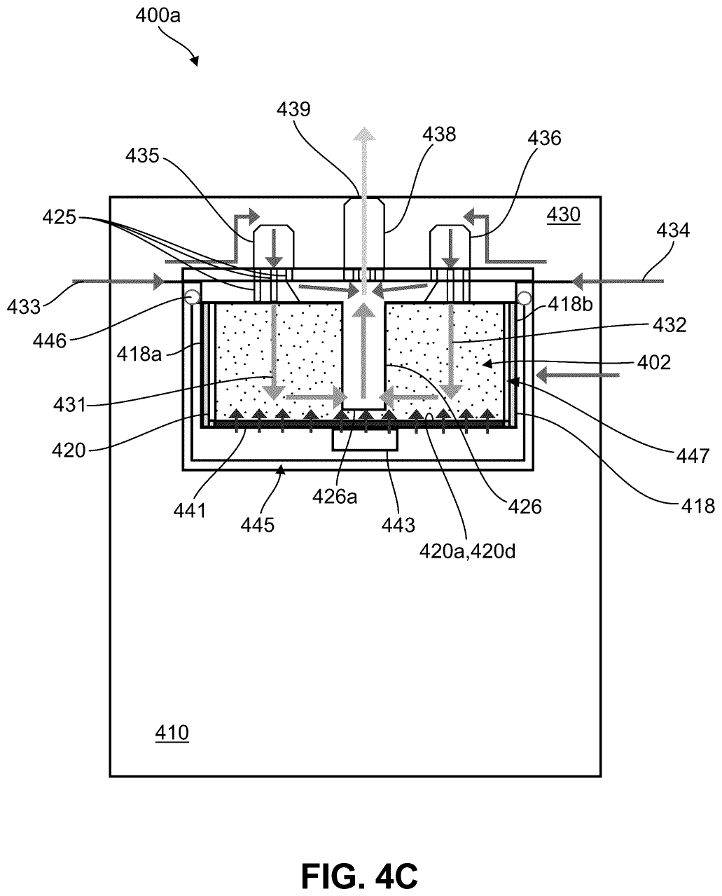

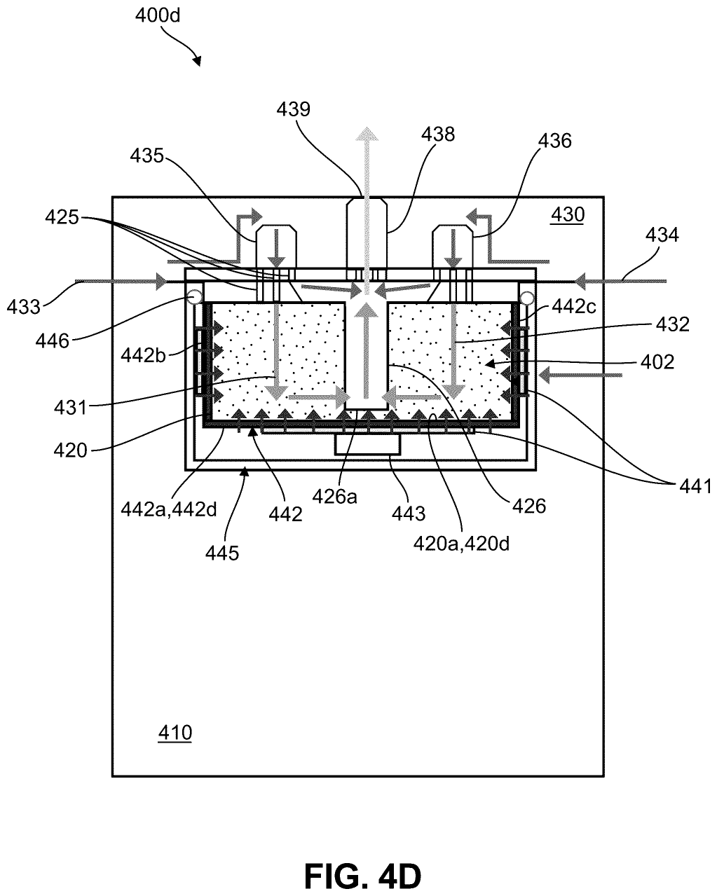

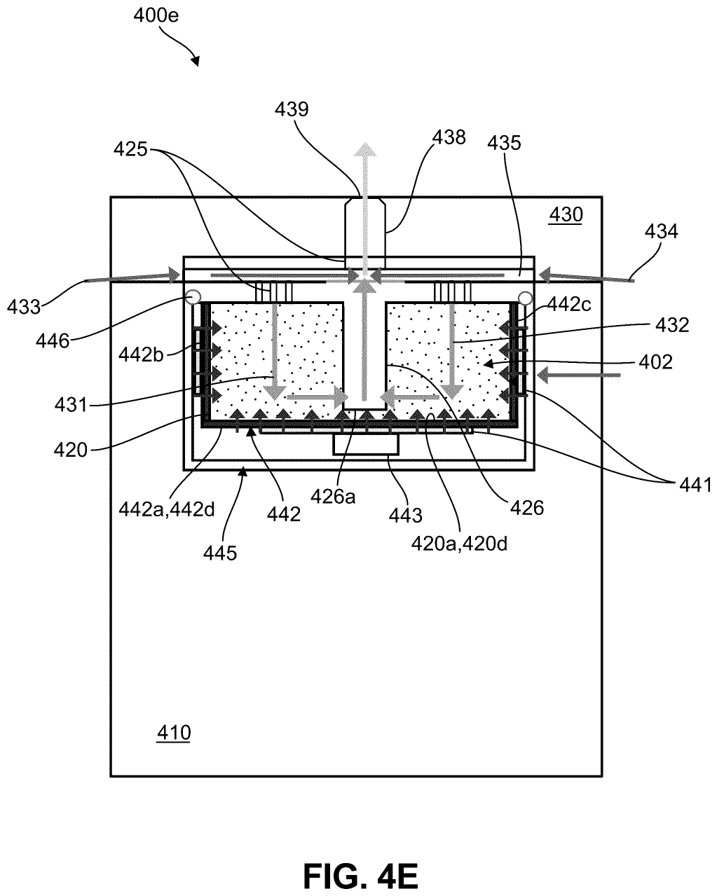

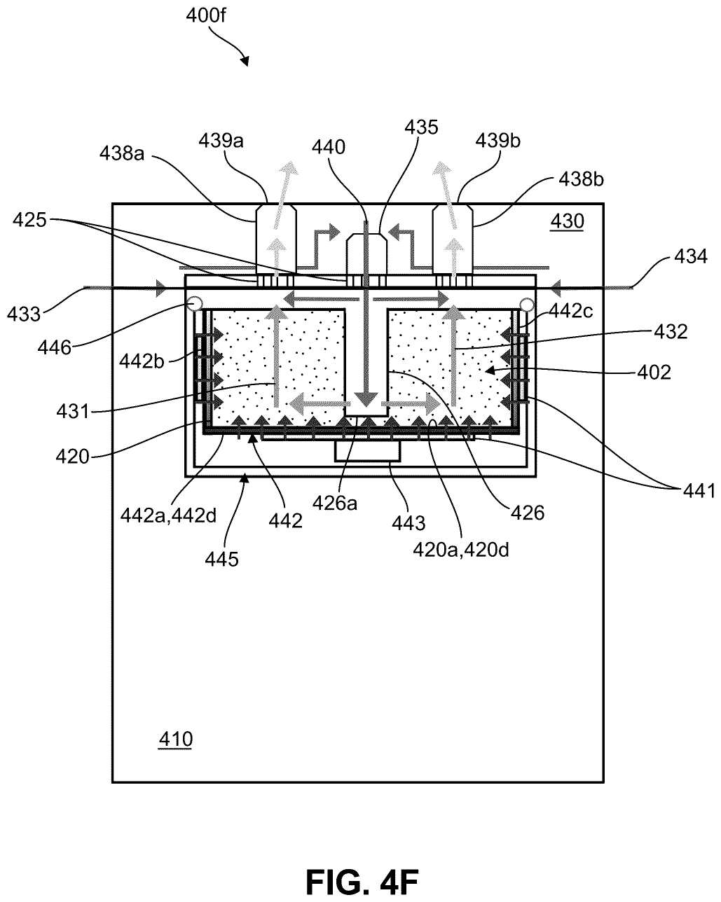

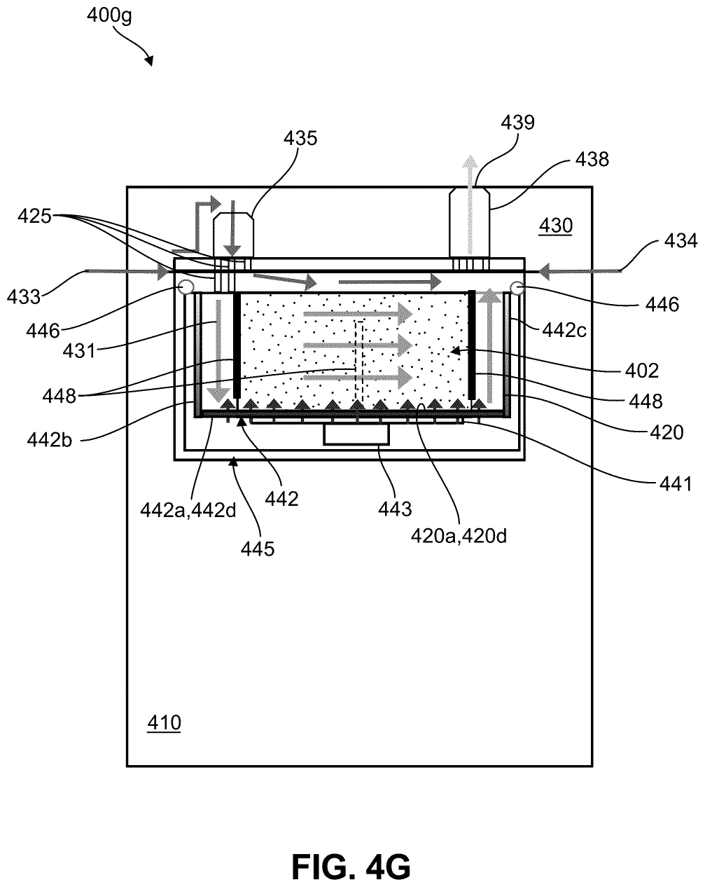

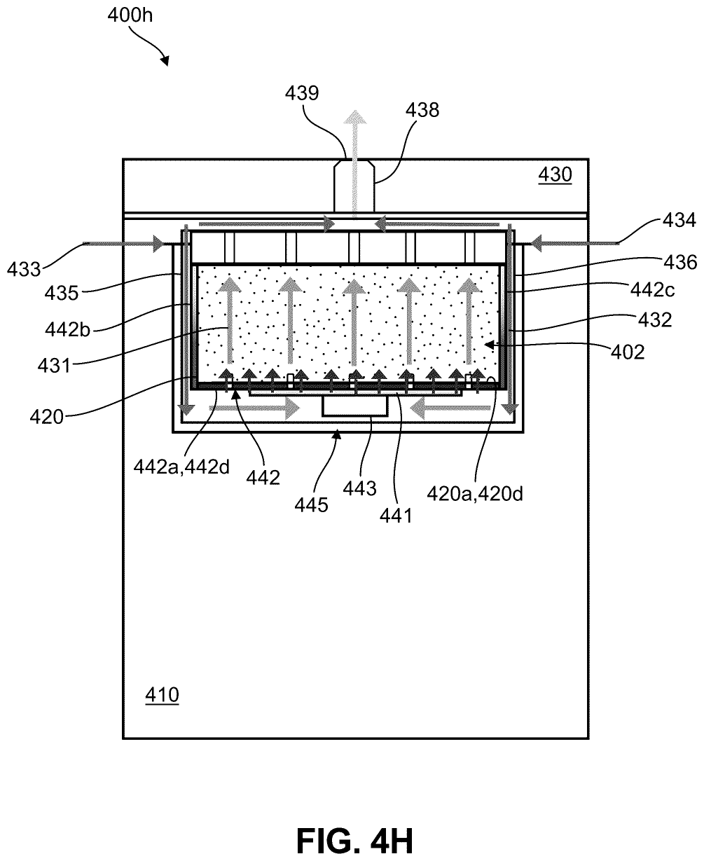

FIGS. 4A-4I illustrate cross-sectional schematics of various implementations of a vaporizer device 400a-i consistent with implementations of the current subject matter. For purposes of simplicity only, certain components of the vaporizer devices 400a-i are not illustrated. Further, these vaporizer devices 400a-i can be implementations of one or more components of the vaporizer device 100 of FIG. 1, the vaporizer device 200 of FIGS. 2A-2B, and/or the cartridge 320 of FIG. 3.

As illustrated in FIG. 4A, the vaporizer device 400, 400a can include a vaporizer body 410, a mouthpiece 430, and/or a cartridge 420 containing a vaporizable material 402. The vaporizer body 410 can include an oven 442 configured to be heated by one or more heating elements 441. The oven 442 can include a region, configured to be heated (e.g., via convective heat), defined at least in part by a bottom wall 442a (distal end 442d) and two opposing side walls 442b, 442c, each extending from the bottom wall 442a. The heat provided by the oven 442 and/or one or more heating elements 441 can heat the vaporizable material 402 to generate an inhalable aerosol, as described herein. In some implementations, the oven 442 can provide an implementation of a receptacle 118 for insertably receiving the cartridge 420.

In some implementations, at least one of the one or more heating elements 441 can be a different type of heater. For example, a first of the one or more heating elements 441 can include a flex heater wrapped (e.g., substantially, a majority, or partially) around the oven 442. Additionally or alternatively, a second of the one or more heating elements 441 can include a surface heater, such a ceramic heater, in thermal contact with the oven 442 (e.g., the bottom wall 442a of the oven 442) (see FIGS. 4A-4B, 4D-4F) or directly (e.g., substantially, a majority, or partially touching) with the cartridge 420 (see FIG. 4C). In some implementations, only one heating element 441 may be present, which can reduce the cost and simplify manufacturability of the vaporizer device 400, 400a. The one or more heating elements 441 can take other forms, such as conductive heater, a radiative heater, and/or a convective heater, as described herein (e.g., by converting one or more compound present in the vaporizable material 402 to the gas phase from which recondensation to an inhalable aerosol can occur). In some implementations, one or more of the heating elements 441 can be built into one or more of the walls 442a, 442b, 442c of the oven 442.

Potentially dependent upon the location and/or type of heaters used, the walls of the cartridge 420 can be configured to physically contact the internal surface of the walls 442a, 442b, 442c of the oven 442 only in certain areas. As described herein, to provide controlled regions of close thermal contact between the cartridge 420 and the walls 442a, 442b, 442c of the oven 442, a container 322 of the cartridge 420 can include a plurality of channels 323 that protrude from and/or extend into the interior of the container 322 of the cartridge 420.

In implementations where only one heating element 441 is provided, such as at or near the distal end of the oven 442 as illustrated in the vaporizer device 400b of FIG. 4B, it can be advantageous to increase the physical contact between the cartridge 420 at or near the distal end of the oven 442 and/or minimize the physical contact between the cartridge 420 and other areas of the oven 442 that are not actively heated, such as the side walls 442b, 442c of the oven 442. The term “side walls” as used herein can refer to walls between the distal and proximal ends of an object, such as the oven 442, the cartridge 420, and/or the like. Accordingly, in addition to or alternatively from using a plurality of channels 323 to space portions (e.g., a majority) of the external surface area (e.g., side walls) of the cartridge 420 away from the side walls of the oven 442, the cartridge 420 can be dimensioned to fit within the oven 442 in a location where side walls 420a, 420b of the cartridge 420 are spaced away from the side walls of the oven 442. The space between the side walls 420a, 420b of the cartridge 420 and the side walls 442b, 442c of the oven 442 is illustrated as air gap 447. It will be appreciated that if the side walls 420a, 420b of the cartridge 420 are in contact with side walls 442b, 442c of the oven 442 that are not actively heated, heat loss can result via heat transfer from the side walls 420a, 420b of the cartridge 420 to the side walls 442b, 442c of the oven 442, resulting in reduced performance. The vaporizer device 400, 400b can include the same components of, and otherwise operate in the same manner as, the vaporizer device 400a of FIG. 4A, except as noted.

In implementations where only one heating element 441 is provided, such as at or near the distal end of the oven 442 as illustrated in the vaporizer device 400c of FIG. 4C, it can be advantageous to place the cartridge 420 in direct contact with the single heating element 441. In such implementations, an oven 442 might not be present, but similar to the vaporizer device 400b of FIG. 4B, in addition to or alternatively from using a plurality of channels 323 to space the majority of the external surface area (e.g., side walls) of the cartridge 420 away from the side walls 418a, 418b of the receptacle 418, the cartridge 420 can be dimensioned to fit within the receptacle 418 in a location where side walls 420a, 420b of the cartridge 420 are spaced away from the side walls 418a, 418b of the receptacle 418. The space between the side walls 420a, 420b of the cartridge 420 and the side walls 418a, 418b of the receptacle is illustrated as air gap 447. The vaporizer device 400, 400c can include the same components of, and otherwise operate in the same manner as, the vaporizer device 400a of FIG. 4A, except as noted.

The vaporizer body 410 can include a thermistor 443 disposed to take resistance and/or temperature measurements based on a temperature of the oven 442 and/or a temperature of the one or more heating elements 441. While the thermistor 443 is illustrated as being in direct contact with the heating element 441, in other implementations, the thermistor 443 can be in direct contact with a wall of the oven 442 (e.g., one or more walls 442a, 442b, 442c (see FIG. 4A)). Alternatively or in addition, in some implementations, the thermistor 443 can be positioned within the vaporizer body 410 (e.g., on at least a portion of an internal surface of one or more walls 442a, 442b, 442c of the oven 442) such that the thermistor directly contacts at least a portion of the cartridge 420 when the cartridge 420 is inserted into the vaporizer body 410.

In order to operate the vaporizer device 400, 400a-c, the controller 104 can execute instructions stored in the memory 108 to perform operations that result in heating the oven 442 and/or one or more heating elements 441 to a target temperature sufficient to release one or more vaporizable compounds from the vaporizable material 402 (e.g., operating temperature). Based on data from the thermistor 443 and/or one or more sensors 113, the operations can monitor the temperature of the oven 442 and/or one or more heating elements 441, and increase or decrease the amount of power supplied to the one or more heating elements 441 such that the temperature of and/or in the oven 442 is within an acceptable range (e.g., operating temperature range). The operations for heating the oven 442 and/or one or more heating elements 441 can be invoked based on one or more parameters, such as whether or not a cartridge 420 is present within the oven 442, whether a signal or pattern of signals is received from an input device 116, 216 (e.g., in response to a user pressing and/or holding a button one or more times within a specified period of time, for a specified period of time, according to a predetermined pattern and/or the like), whether there is sufficient power remaining in the power source 112, and/or the like. In some implementations, the operations can include stopping the flow of power to the one or more heating elements 441 based on one or more parameters, such as a cartridge 420 being removed, whether the one or more heating elements 441 have been active for more than a predefined period of time, based on data from one or more sensors 113 (e.g., a lack of motion for a predefined period of time, a lack of use of the device based on a lack of a detected drop in temperature from a thermistor for a predefined period of time), whether a signal or pattern of signals is received from an input device 116, 216 (e.g., in response to a user pressing and/or holding a button one or more times within a specified period of time, for a specified period of time, according to a predetermined pattern and/or the like), whether there is sufficient power remaining in the power source 112, and/or the like.

The vaporizer body 410 can include insulation 445 to insulate the rest of the vaporizer body 410 (e.g., controller 104, power source 112, external shell or casing, etc.) from the heat of the oven 442 and/or the one or more heating elements 441. In some implementations, the insulation 445 can include a vacuum-insulated Dewar. Although a primary insulation 445 is illustrated, one or more secondary insulation regions and/or materials may be present within the vaporizer device 400, 400a-c. The vaporizer body 410 can include one or more seals 446 to help seal the oven 442 from the rest of the vaporizer body 410. In some implementations, the one or more seals 446 can include an o-ring seal.

A first airflow path 431 and a second airflow path 432 can be defined at least in part by the vaporizer body 410, mouthpiece 430, cartridge 420, and/or vaporizable material 402. The first airflow path 431 and the second airflow path 432 can be configured to direct the flow of air from outside of the vaporizer device 400, 400a-c, into the vaporizer device 400, 400a-c, within the vaporizer device 400, 400a-c, and out of the vaporizer device 400, 400a-c. Although two airflow paths 431, 432 are illustrated and described, in some implementations, only one airflow path may be present or more than two airflow paths may be present.

As illustrated, the first airflow path 431 can include and/or be defined at least in part by one or more of a first airflow inlet 433, a first airflow channel 435, holes 425 (e.g., including a plurality of through-holes 325a, 325b, one or more channels 329a (illustrated as angled walls), a central opening 328a, one or more entrance holes 329b, one or more exit holes 328b), the cartridge 420 (e.g., including a base component 324a, a perforated lid 324b, and/or container 322), the vaporizable material 402, a shaft 426 (e.g., including one or more shaft through-holes 327), an airflow outlet channel 438, and/or an airflow outlet 439. The second airflow path 432 can include and/or be defined at least in part by one or more of a second airflow inlet 434, a second airflow channel 436, holes 425 (e.g., including a plurality of through-holes 325a, 325b, one or more channels 329a (illustrated as angled walls), a central opening 328a, one or more entrance holes 329b, one or more exit holes 328b), the cartridge 420 (e.g., including a base component 324a, a perforated lid 324b, and/or container 322), the vaporizable material 402, a shaft 426 (e.g., including one or more shaft through-holes 327), an airflow outlet channel 438, and/or an airflow outlet 439.

As illustrated, the mouthpiece 430 can include the first airflow inlet 433 in fluid communication with the first airflow channel 435, and/or the second airflow inlet 434 in fluid communication with a second airflow channel 436. Although first and second airflow inlets 433, 434 are illustrated as being formed towards and/or by the intersection of the mouthpiece 430 and the vaporizer body 410, the first and second airflow inlets 433, 434 can be located in different locations. For example, first and second airflow inlets 433, 434 can be formed elsewhere in the mouthpiece 430, such as on the front or back side of the vaporizer device 400, 400a-c (not shown), the proximal end of the mouthpiece 430, and/or the like. In other implementations, the mouthpiece 430 can include one airflow inlet or more than two airflow inlets. In some implementations, the mouthpiece 430 can include one or more features configured to direct the flow of air between the first and second airflow inlets 433, 434 and the first and second airflow channels 435, 436. For example, the mouthpiece 430 can include one or more regions that are configured to remain hollow when the mouthpiece 430 is closed against the vaporizer body 410, such that air may flow between the first and second airflow inlets 433, 434 and the first and second airflow channels 435, 436.

The mouthpiece 430 can include an airflow outlet channel 438 in fluid communication with an airflow outlet 439. In some implementations, the distal ends (e.g., bottom surface) of one or both of the first and second airflow channels 435, 436 and/or the airflow outlet channel 438 can be disposed to press against a proximal end (e.g., lid 324) of the cartridge 420 to provide a better seal for the airflow paths 431, 432. In some implementations, the first and second airflow channels 435, 436 and/or the airflow outlet channel 438 can include a rubber-like material (e.g., silicone) at their respective, distal ends to provide a better seal. In some implementations, the mouthpiece 430 and the vaporizer body 410 can be configured to remain closed even while force is being applied to open the mouthpiece 430 due to the first and second airflow channels 435, 436 and/or the airflow outlet channel 438 being pressed against the cartridge 420. In some implementations, the distal end of the cartridge 420 can include one or more crumple zones (e.g., one or more channels 323, as described herein), which can be configured to compress when the mouthpiece 430 closes down on the vaporizer body 410.

After air enters the first and second airflow channels 435, 436, it can be directed to move towards and through a plurality of holes 425 in the cartridge 420. At least a portion of the air that enters the holes 425 can then pass through the vaporizable material 402 along the first airflow path 431 and the second airflow path 432. As air passes through the container 422 and/or vaporizable material 402, the air becomes heated via the oven 442 and/or one or more heating element 441, as described herein. The air along the airflow paths 431, 432 can thereby become sufficiently heated to cause conversion of some amount of one or more compounds present in the vaporizable material 402 to the gas phase. Air along the airflow paths 431, 432 can mix with and carry vaporized material (e.g., the one or more gas-phase compounds) towards the airflow outlet channel (e.g., air outlet channel 438 in FIGS. 4A-4E and 4G-4H) or first and second airflow outlet channels 438a, 438b in FIG. 4F).

The combination of the plurality of holes 435 and the airflow paths 431, 432 allows for a more even distribution of airflow (e.g., substantially uniform or completely uniform airflow) through the bulk of the vaporizable material. This can effect a more uniform heating across the vaporizable material, and consequently, a more even depletion of the vaporizable material during use, which reduces waste (e.g., the amount of vaporizable material remaining in a disposed cartridge).

The porosity of the vaporizable material 402 can depend at least upon the packing density of the vaporizable material 402 (e.g., level of compression), granularity of the tobacco material (e.g., average size of tobacco pieces) within the vaporizable material 402, and humectant loading (e.g., amount of carrier present, such as Vegetable Glycerin (VG) and/or Propylene Glycol (PG)) within the vaporizable material 402. In turn, the rate of airflow through the vaporizable material 402 can be affected by the porosity of the vaporizable material 402. Accordingly, in some implementations, packing density, granularity, and amount of carrier can vary to achieve a desired consistency and/or quality of inhalable aerosol, as described herein.

As illustrated, the first and second airflow paths 431, 432 can combine in a central location of the cartridge 420, such as within an internal shaft 426 of the cartridge 420, as described herein. For example, the first and second airflow paths 431, 432 can pass into the shaft 426 by way of one or more shaft through-holes 327. The combined first and second airflow paths 431, 432 can then deliver the vaporized material towards the airflow outlet 439 (where a vacuum is being applied (e.g., by suction of a user) and causing air to flow along the airflow paths 431, 432). The vaporized material passing through the shaft 426 can condense within the shaft 426. Accordingly, the shaft 426 can be referred to as a condensation chamber or condensation region.

As illustrated, the distal end 426a of the shaft 426 can be spaced apart from the distal end 420d of the cartridge 420 and/or vaporizable material 402 may be present within the cartridge 420 between the distal end 426a of the shaft 426 and (the inside of) the distal end 420d of the cartridge 420. In some aspects, spacing the shaft 426 away from the heated region of the cartridge 420 can help to keep the temperature relatively low within the shaft 426, which can help to cool the vaporized material quicker. In related aspects, providing vaporizable material 402 at or near the heated region of the cartridge 420 can increase the overall efficiency of vaporization, as vaporization in this region will be relatively high over time.

However, in some implementations, it may be desirable to keep the shaft 426 relatively hot, to reduce the likelihood of condensation forming on the interior walls of the shaft 426. Accordingly, the distal end 426a of the shaft 426 may be pressed against (the inside of) the distal end 420d of the cartridge 420 to heat the shaft 426. Alternatively, in some implementations, the distal end 426a of the shaft 426 may be close to (the inside of) the distal end 420d of the cartridge 420. For example, the distal end 426a of shaft 426 can be spaced from the distal end 420d of the cartridge 420 at a distance between 0 to 2 millimeters or between 0 to 1 millimeters. In some implementations, the distal end 426a of the shaft 426 can be shaped into a tip, which may be pointed or terminate at a flattened end (e.g., an end extending in a traverse direction relative to the longitudinal axis of the shaft 426). In accordance with implementations in which the distal end shaft is shaped into a tip, the cartridge 420 can be filled with vaporizable material 402 and the shaft 426 can more efficiently push the vaporizable material 402 out of the way during the manufacturing process. Pushing the vaporizable material 402 out of the way rather than compressing the vaporizable material 402 can be advantageous, as described herein.

It will be appreciated that, as the one or more compounds converted to the gas phase by heating of the vaporizable material are cooled, condensation and formation of an inhalable aerosol will occur. Depending on how and where the cooling occurs, condensate may form and/or be deposited on the walls of the vaporizer body 410, cartridge 420, and/or mouthpiece 430, especially where the air mass containing the one or more compounds is still relatively hot and comes in contact with a relatively cool wall. Accordingly, to mitigate formation and deposition of condensate, it can be beneficial to sufficiently mix cool air with the combined airflow paths 431, 432, which include vaporized material (e.g., the one or more compounds released to the gas phase via the heating of the vaporizable material 402), as early as possible.

As illustrated, in some implementations, at least a portion of the (cool) air that enters the holes 425 in the cartridge 420 can be directed (e.g., via angled walls) towards a location where the (heated) combined first and second airflow paths 431, 432 pass through the cartridge 420. As such, the air from the holes 425 can mix with the combined first and second airflow paths 431, 432, to decrease the temperature of the vaporized material in the combined first and second airflow paths 431, 432 and promote proper aerosol formation. The regions of the cartridge 420 where the relatively cool air stream from the holes 425 meets with the combined first and second airflow paths 431, 432 (e.g., the shaft 426, the central opening 328a, the holes 425 downstream from the central opening 328a) can be referred to as condensation chambers or condensation regions.

In some implementations, in order to promote the mixing of cool air and the vaporized material (e.g., to condense the one or more compounds of the vaporizable material in the gas phase into an aerosol), the cartridge 420 can include one or more features to create a vortex or otherwise direct airflow in a non-linear fashion, such as one or more obstructions in the first and second airflow paths 431, 432, holes of a particular geometry (e.g., shape, size, angle), holes in a particular location, number of holes, and/or the like.

After this mixing occurs, the resulting aerosol continues to travel along the combined first and second airflow paths 431, 432, through holes 425 in fluid communication with an airflow outlet channel 438. Provided that the aerosol is sufficiently cool by the time it enters the airflow outlet channel 438, the likelihood of condensation of the compounds released by heating of the vaporizable material onto internal surfaces (e.g., walls of the airflow outlet channel 438) is reduced. The airflow outlet channel 438 can be in fluid communication with the airflow outlet 439 such that the inhalable aerosol may travel along the combined airflow paths 431, 432 and out of the mouthpiece 430 (e.g., to a user). The vaporized material (e.g., the one or more compounds) passing through the airflow outlet channel 438 can condense within the airflow outlet channel 438. Accordingly, the airflow outlet channel 438 can be referred to as a condensation chamber or condensation region.

Additionally or alternatively, as illustrated in the vaporizer device 400d of FIG. 4D, the mixing of cool air with the combined first and second airflow paths 431, 432, which include vaporized material, can occur outside of the cartridge 420. For example, in some implementations, in order to promote the mixing of cool air with the combined first and second airflow paths 431, 432, the airflow outlet channel 438 can include one or more pathways for cool air to enter (e.g., from the airflow inlets 433, 434) and mix with the combined first and second airflow paths 431, 432. The airflow outlet channel 438 can include one or more features to create a vortex or otherwise direct airflow in a non-linear fashion, such as one or more obstructions in or extending from the walls of the airflow outlet channel 438, holes of a particular geometry (e.g., shape, size, angle), holes in a particular location, number of holes, and/or the like. Alone or in combination with any features of the airflow outlet channel 438 that are configured to direct airflow in a non-linear fashion, the cartridge 420 can include one or more features to direct airflow in a non-linear fashion, such as one or more obstructions in or extending from the walls of the airflow outlet channel 438, holes of a particular geometry (e.g., shape, size, angle), holes in a particular location, number of holes, and/or the like. The vaporizer device 400, 400d can include the same components of, and otherwise operate in the same manner as, any of the vaporizer devices 400, 400a-c of FIG. 4A-C, except as noted.

In some implementations, the first and second airflow channels 435, 436 may not be present within the mouthpiece 430. For example, as illustrated in the vaporizer device 400c of FIG. 4E, the first and second airflow paths 431, 432 can be defined at least in part by an airflow channel 435 in fluid communication with each of the first and second airflow inlets 433, 434. The airflow channel 435 can be defined in a lid of the cartridge 420 (e.g., lid 324) such as between a base component and a top layer of the cartridge 420 (e.g., similar to the base component 324a and the top barrier 324c, respectively). In some implementations, the airflow channel 435 can be defined between a component that is the functional equivalent of a base component combined with a perforated top (e.g., one unitary piece or two combined pieces, similar to the base component 324a and perforated lid 324b) and a top layer of the cartridge 420 (e.g., similar to the top barrier 324c).

As illustrated, the airflow channel 435 includes a central region that is open, where (cool) air from the airflow inlets 433, 434 can mix with the (heated) combined airflow paths 431, 432. One or more features to create a vortex or otherwise direct airflow in a non-linear fashion, as described herein, may be present at or near this central region. Although all of the holes 425 are illustrated as through-holes and the airflow channel 435 is depicted as including a central region that is open, one or more channels may be present within the cartridge 420 (e.g., similar to the angled walls in the cartridge 420 of the vaporizer device 400a of FIG. 4A and/or the one or more channels 329a of FIG. 3) and/or the central region of the airflow channel 435 may be closed (e.g., and instead include additional holes 425). The vaporizer device 400, 400e can include the same components of, and otherwise operate in the same manner as, any of the vaporizer devices 400a-d of FIGS. 4A-D, except as noted.

In some implementations, as illustrated in the vaporizer device 400f of FIG. 4F, the direction of airflow can be reversed (e.g., relative to the vaporizer devices 400a-e of FIGS. 4A-E). In such implementations, the mouthpiece 430 can include an airflow inlet channel 435, a first airflow outlet channel 438a in fluid communication with a first airflow outlet 439a, and/or a second airflow outlet channel 438b in fluid communication with a second airflow outlet 439b. Additionally or alternatively, the cartridge 420 can include a different configuration of holes 425, such as by including a larger open area in the base component 324a and/or no (or less) through-holes 325a in the base component 324a.

As illustrated, an airflow path 440 can include and/or be defined at least in part by one or more of a first airflow inlet 433, a second airflow inlet 434, an airflow channel 435, holes 425 (e.g., including one or more exit holes 328b, a central opening 328a, one or more channels 329a, one or more entrance holes 329b, and/or a plurality of through-holes 325a, 325b), a shaft 426 (e.g., including one or more shaft through-holes 327), a first airflow path 431, a second airflow path 432, the cartridge 420 (e.g., including a base component 324a, a perforated lid 324b, and/or container 322), the vaporizable material 402, a first airflow outlet channel 438a, a second airflow outlet channel 438b, a first airflow outlet 439a, and/or a second airflow outlet 439b.

The airflow path 440 can be configured to provide ambient air to a hot region of the cartridge 420 (e.g., near the bottom wall 442a of the oven 442 at or near the one or more heating elements 441, which is potentially the hottest region of the cartridge 420 prior to air flowing through the vaporizer device 400, 400f), such that heated air is more evenly distributed across the vaporizable material 402 (e.g., relative to the vaporizer devices 400a-c of FIGS. 4A-E). The vaporizer device 400, 400f can include the same components of, and otherwise operate in the same manner as, any of the vaporizer devices 400a-e of FIGS. 4A-E, except as noted.

In some implementations, as illustrated in the vaporizer device 400g of FIG. 4G, the cartridge 420 can include one or more baffles 448. In accordance with these implementations, only one airflow inlet 433 in fluid communication with one airflow inlet channel 435 and/or one airflow outlet 439 in fluid communication with one airflow outlet channel 438 may be present, to provide for a more unidirectional airflow path 431. However, an additional airflow inlet 434 (not shown) may be present, such as to provide additional ambient air for mixing with the (heated) airflow path 431 and aid with aerosol generation.

As illustrated, the airflow path 431 may enter on one side of the cartridge 420 and exit on the opposite side of the cartridge 420. A first baffle 448 near where the airflow path 431 enters the cartridge 420 may be configured to direct the airflow path 431 to the distal end of the cartridge (e.g., near the distal end of the oven 442), and may terminate in a distal edge that provides a gap for the airflow path 431 to enter the vaporizable material 402. In some implementations, the first baffle 448 can include one or more holes dimensioned to allow for the passage of air through the first baffle 448. If a plurality of holes are present in the first baffle 448, they may be of different diameters, such as increasing in diameter from the proximal edge to the distal edge of the first baffle 448.

The airflow path 431 can pass through the vaporizable material 402 towards a second baffle 448, potentially passing at different rates (e.g., speeds, volumes, etc.) at different levels of the vaporizable material 402 (e.g., more proximate to or distal from the distal end of the oven 442). The second baffle 448 can be near where the airflow path 431 exits the cartridge, may be configured to direct the airflow path 431 to the distal end of the cartridge (e.g., near the distal end of the oven 442), and/or may terminate in a distal edge that provides a gap for the airflow path 431 to exit the vaporizable material 402. In some implementations, the second baffle 448 can include one or more holes dimensioned to allow for the passage of air through the second baffle 448. If a plurality of holes are present in the first baffle 448, they may be of different diameters, such as increasing or decreasing in diameter from the proximal edge to the distal edge of the first baffle 448.

After the airflow path 431 exits the vaporizable material 402, it may combine with a (cool) air stream, such as within the lid of the cartridge 420 and/or outside of the cartridge 420. For example, at least a portion of the (cool) air that enters the holes 425 in the cartridge 420 can be directed towards a location where the (heated) airflow path 431 passes through the cartridge 420. As such, the air from the holes 425 can mix with the airflow path 431 to decrease the temperature of the vaporized material in the airflow path 431 and promote proper aerosol formation. Because the vaporizable material 402 may not occupy the full width of the cartridge 420, in some implementations, the cartridge 420 is only heated from the distal end 420d (e.g., via on heating element 441).

In some implementations, more than one or two baffles 448 may be present. The presence of additional baffles may help to further guide the airflow path 431 to allow for a more even distribution of heat across the vaporizable material 402. A plurality of baffles 448 can be used to form a C-shaped path, S-shaped path, snake-shaped path, and/or the like. Although one or more baffles 448 are generally discussed with respect to the vaporizer device 400g of FIG. 4G, one or more baffles 448 may be included within any of the cartridges 420 of FIGS. 4A-F. The vaporizer device 400, 400g can include the same components of, and otherwise operate in the same manner as, any of the vaporizer devices 400a-f of FIGS. 4A-F, except as noted.

In some implementations, as illustrated in the vaporizer device 400h of FIG. 4H, the oven 442 and/or the cartridge 420 can include one or more holes in their respective distal ends 442d, 420d. In accordance with such implementations, the first and second airflow paths 431, 432 can be configured to direct air from the first and second airflow inlets 433, 434 down and around the side walls 442b, 442c of the oven 442 and/or side walls of the cartridge 420. However, providing holes in the distal end 420d of the cartridge 420 or any region of the cartridge 420 that comes into contact with a heated surface can increase the likelihood that the vaporizable material 402 itself will come into contact with the heated surface, thereby increasing the likelihood that the vaporizer device 400, 400h will experience performance issues over time (e.g., due to residue, buildup, burning, etc.). Accordingly, as described herein, the vaporizer devices 400a-g of FIGS. 4A-G, where no vaporizable material 402 (before or after being vaporized) touches a heated surface, can provide advantages over the vaporizer device 400h of FIG. 4H. The vaporizer device 400, 400h can include the same components of, and otherwise operate in the same manner as, any of the vaporizer devices 400a-g of FIGS. 4A-G, except as noted.

In some implementations, as illustrated in the vaporizer device 400i of FIG. 4I, the first and second airflow inlets 433, 434 can be configured to direct air to the holes 425 without the presence of the first and second airflow channels 435, 436 in the mouthpiece 430 (similar to the vaporizer device 400c). In accordance with such implementations, the mouthpiece 430 can be configured to allow at least a portion of the first and second airflow inlets 433, 434 to be exposed to ambient air, such that ambient air may enter the vaporizer device 400i and travel along the first and second airflow paths 433, 434. The vaporizer device 400, 400i can include the same components of, and otherwise operate in the same manner as, any of the vaporizer devices 400a-h of FIGS. 4A-H, except as noted.

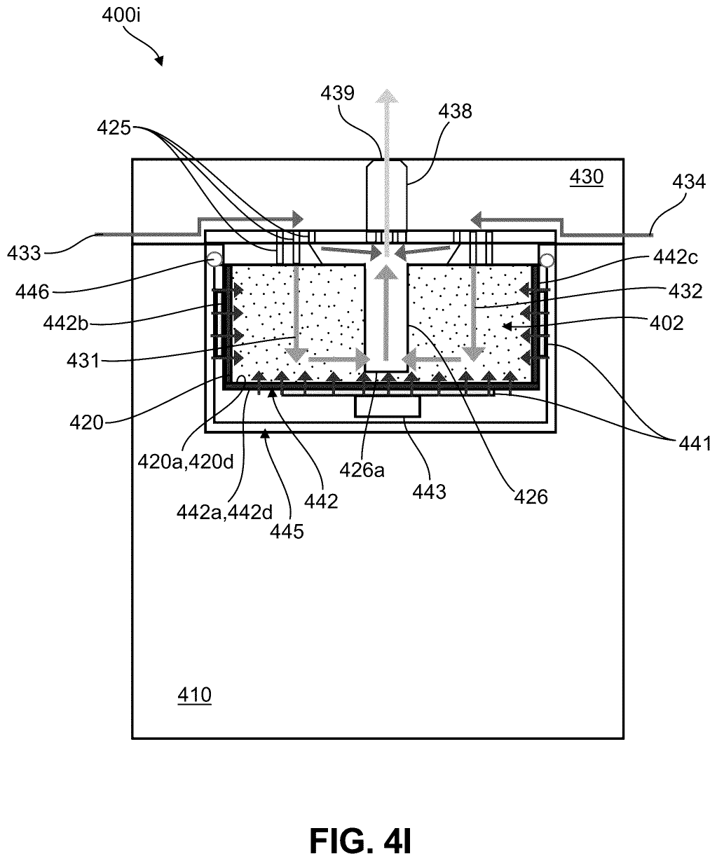

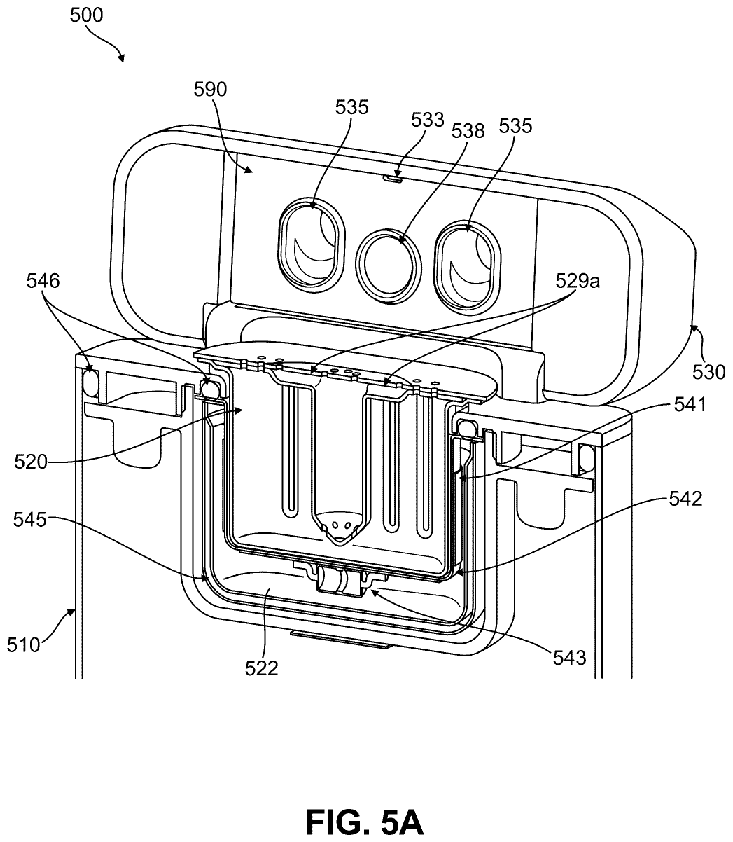

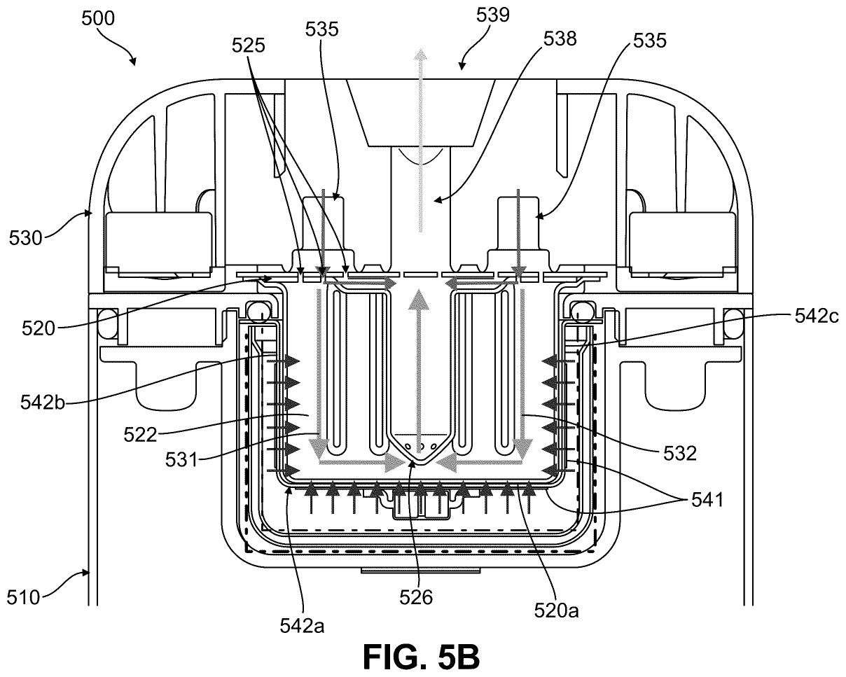

FIGS. 5A-5B illustrate cross-sectional views of implementations of a vaporizer device 500, consistent with implementations of the current subject matter. For purposes of simplicity only, certain components of the vaporizer devices 500 are not illustrated. Further, these vaporizer devices 500 can be implementations of one or more components of the vaporizer device 100 of FIG. 1, the vaporizer device 200 of FIGS. 2A-2B, the cartridge 320 of FIG. 3, and/or the vaporizer devices 400, 400a-400i of FIGS. 4A-4I.

As illustrated in FIG. 5A, the vaporizer device 500 can include a vaporizer body 510, a mouthpiece 530, and/or a cartridge 520 configured to contain a vaporizable material. The vaporizer body 510 can include an oven 542 configured to be heated by one or more heating elements 541. The vaporizer device 500 can additionally include insulation 545 and/or seals 546 configured to reduce heat transfer to other portions of the vaporizer device 500 (e.g., electronic components within the vaporizer body 510, the outer shell of the vaporizer device 500, the mouthpiece 530, and/or the like). As further illustrated, the vaporizer device 500 can include a thermistor 543, which can be operable to assist in regulating the temperature of the oven 542, as described herein.

As illustrated, the mouthpiece 530 can include at least one airflow inlet 533, one or more airflow channels 535, and/or an airflow outlet channel 538. As described herein, the at least one airflow inlet 533 can be in fluid communication with the one or more airflow channels 535, which in turn can be configured to provide air to the cartridge 520. In some implementations, the one or more airflow channels 535 and/or the airflow outlet channel 538 can include a sealing ring configured to provide a seal between the respective channel and a corresponding section of the cartridge 520. In some implementations, at least a portion of the one or more airflow channels 535 and/or the airflow outlet channel 538 can be part of a removable insert 590, which may be configured to detach from the mouthpiece 530 (e.g., for cleaning).

The cartridge 520 can include channels 529a, beneath and defined at least in part by a perforated lid, configured to direct air into an airflow path through the cartridge 520, as described in greater detail with respect to FIG. 5B. Further, as shown in FIGS. 5A-5B, the cartridge 520 can include a container 522 that can house vaporizable material (not shown).

As illustrated in FIG. 5B, the oven 542 can include a region, defined at least in part by a bottom wall 542a (distal end) and two opposing side walls 542b, 542c, each extending from the bottom wall 542a. The one or more heating elements 541 can be configured to heat one or more of the walls 542a, 542b, 542c of the oven 542 via conductive and/or convective heat. For example, the one or more heating elements 541 can heat the walls 542a, 542b, 542c of the oven 542 via conductive heat in locations of the oven 542 where the walls 542a, 542b, 542c of the oven 542 are in physical contact with the one or more heating elements 541 and/or convective heat in locations of the oven 542 where the walls 542a, 542b, 542c of the oven 542 are in thermal contact but not physical contact with the one or more heating elements 541. The heat provided by the oven 542 and/or one or more heating elements 541 can heat the cartridge 520 and thereby heat the vaporizable material contained therein to generate an inhalable aerosol, as described herein. For example, the oven 542 can heat the cartridge 520 via conductive heat in locations of the cartridge 520 where the cartridge 520 is in physical contact with the walls 542a, 542b, 542c of the oven 542 and/or convective heat in locations of the cartridge 520 where the cartridge 520 is in thermal contact but not physical contact with the walls 542a, 542b, 542c of the oven 542. Additionally or alternatively, the one or more heating elements 541 can heat the cartridge 520 via conductive heat in locations of the cartridge 520 where the cartridge 520 is in physical contact with the one or more heating elements 541 and/or convective heat in locations of the cartridge 520 where the cartridge 520 is in thermal contact but not physical contact with the one or more heating elements 541.

In some implementations, the oven 542 can provide an implementation of a receptacle 118 for insertably receiving the cartridge 520. As illustrated, a side wall 520a (e.g., bottom) of the cartridge 520 can be configured to contact the bottom wall 542a of the oven 542 to provide heat transfer to the vaporizable material contained within the cartridge (not illustrated). As illustrated, the one or more heating elements 541 can include a flex heater wrapped (e.g., substantially, a majority, or partially) around the oven 542. However, the one or more heating elements 541 can take other forms, as described herein.

As described herein, ambient air may enter the vaporizer device 500 from outside via an airflow inlet 533. The air entering the airflow inlet 533 can be directed to the airflow channels 535, and thereafter provided to a plurality of holes 525 in a lid of the cartridge 520. At least a portion of the holes 525 can be configured to direct air into a container portion of the cartridge 520 while another portion of the holes 525 can be configured to direct air into the channels 529a within the cartridge 520, physically separate from the container portion. The air that enters the container portion of the cartridge 520 can traverse first and second airflow paths 531, 532, which are heated by the at least one heating element 541 and/or the oven 542. The heated air passing along the first and second airflow paths 531, 532 can pass through vaporizable material contained within the container portion of the cartridge 520, and the vaporized material generated as a result can be delivered to the shaft 526 in the middle and/or center of the cartridge 520.

The combined first and second airflow paths 531, 532 can then travel up the shaft 526 and mix with the air passing through the channels 529a of the cartridge 520 to be cooled to generate an inhalable aerosol. Thereafter, the combined and cooled first and second airflow paths 531, 532 can deliver the generated aerosol to the airflow outlet channel 538, where the aerosol is directed out of the airflow outlet 539 to a user.

The vaporizer device 500 can include the same components of, and otherwise operate in the same manner as, any of the vaporizer device 100 of FIG. 1, vaporizer device 200 of FIGS. 2A-2B, vaporizer devices 400a-i of FIGS. 4A-4I, and/or any other vaporizer device described herein, except as noted.

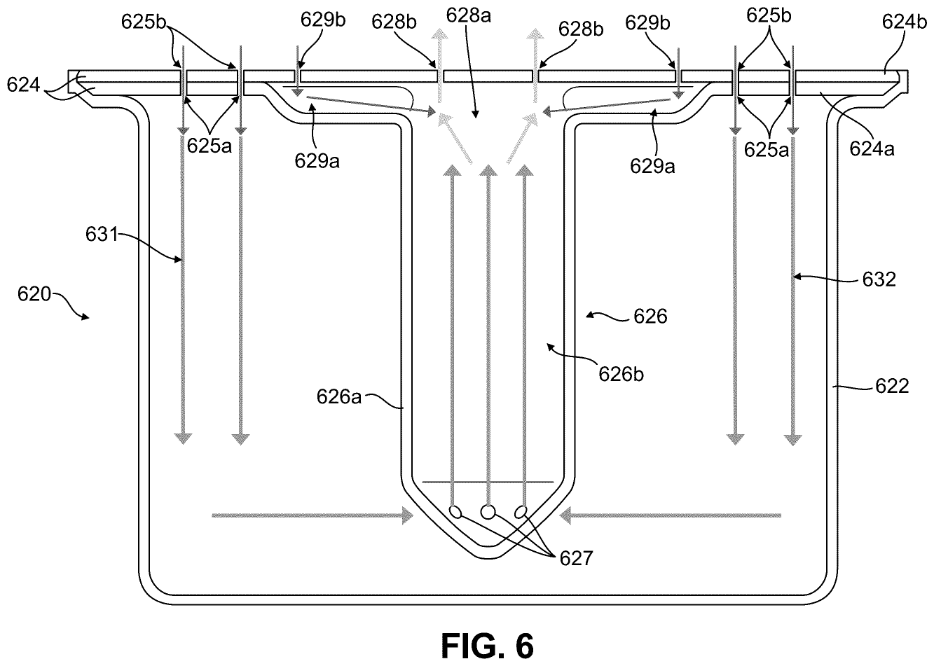

FIG. 6 illustrates a cross-sectional view of an implementation of a cartridge 620 having a container 622 and a lid 624, showing airflow paths (illustrated as arrows) into, through, and out of the cartridge 620. The cartridge 620 is similar to the cartridge 420 in FIG. 4A and therefore similar components are not described in detail herein. The lid 624 can include one or more different components, such as a base component 624a and a perforated lid 624b. The base component can include a shaft 626, a plurality of through-holes 625a, one or more channels 629a, and/or a central opening 628a. The plurality of through-holes 625a can be in fluid communication with the container 622. In this illustrated implementation, the plurality of through-holes 625a are configured to deliver air to or towards the container 622. The one or more channels 629a can be in fluid communication with the central opening 628a. As shown, the one or more channels 629a are configured to deliver air to or towards the central opening 628a to allow the air to mix with the vaporized material exiting the shaft 626. Since the air is relatively cooler compared to the air mass containing the vaporized material, the mixing thereof promotes nucleation of the vaporized material into an inhalable aerosol, as described above. Although the central opening 628a is illustrated and described as being central to the base component 624a, in some implementations, the central opening 628a can be off-center (e.g., simply and “opening” that provides the same or similar functionality). Although only one central opening 628a is illustrated and described, in some implementations, more than one central opening 628a may be present, which may be “centralized” across one, two, three, or even no dimensions of the base component 624a.

As further shown, the shaft 626 may include one or more shaft through-holes 627 extending through the wall(s) 626a of the shaft 626. The one or more shaft through-holes 627 can be in fluid communication with an interior channel 626b of shaft 626 and/or with the container 622. In this illustrated implementation, the one or more shaft through-holes 627 are configured to deliver air and vaporized material from the container to the interior channel of shaft 626.

As illustrated, the perforated lid 624b can include a plurality of through-holes 625b, one or more entrance holes 629b, and/or one or more exit holes 628b. The plurality of through-holes 625b of the perforated lid 624b are aligned with the plurality of through-holes 625a of the base component 624a and therefore in fluid communication therewith. As such, the plurality of through-holes 625b of the perforated lid 624b can be configured to deliver air to or towards the plurality of through-holes 625a of the base component 624a, as shown in FIG. 6 (e.g., when a vacuum is being applied (e.g., by suction of a user) while the cartridge 620 is inserted within a receptacle of a vaporizer device).

In this illustrated implementation, the one or more entrance holes 629b overlap with at least a portion of one or more of the one or more channels 629a of the base component 624a and therefore are in fluid communication with the one or more channels 629a of the base component 624a. As such, the one or more entrance holes 629b of the perforated lid 624b are configured to deliver air to or towards the one or more channels 629a of the base component 624a. The one or more exit holes 628b overlap with at least a portion of the central opening 628a of the base component 624a and therefore are in fluid communication with the central opening 628a of the base component 624a. As such, the one or more exit holes 628b of the perforated lid 624b are configured to withdraw air from the central opening 628a of the base component 624a (e.g., and towards an air outlet of a mouthpiece).

As further shown in FIG. 6, a first airflow path 631 and a second airflow path 632 extend through the cartridge 620. More specifically, the first airflow path 631 is defined at least in part by one or more the plurality of through-holes 625a, 625b, one or more channels 629a, a central opening 628a, one or more entrance holes 629b, one or more exit holes 628b. The second airflow path 632 is defined at least in part a plurality of through-holes 625a, 625b, one or more channels 629a (illustrated as angled walls), a central opening 628a, one or more entrance holes 629b, one or more shaft through-holes 627 and one or more exit holes 628b.

As illustrated, the first and second airflow paths 631, 632 combine within interior channel 626b of shaft 326 of the cartridge 620. The combined first and second airflow paths 631, 632 can then deliver the vaporized material towards the central opening 628a of the shaft. Upon exiting the shaft 626 through the central opening 628a, the vaporized material mixes with the air being delivered into the cartridge 620 through the one or more entrance holes 629b of the perforated lid and the one or more channels 629a of the base component 624a mixes with the vaporized material. This mixing promotes the nucleation of the vaporized material into an inhalable aerosol (e.g., for subsequent inhalation by a user).

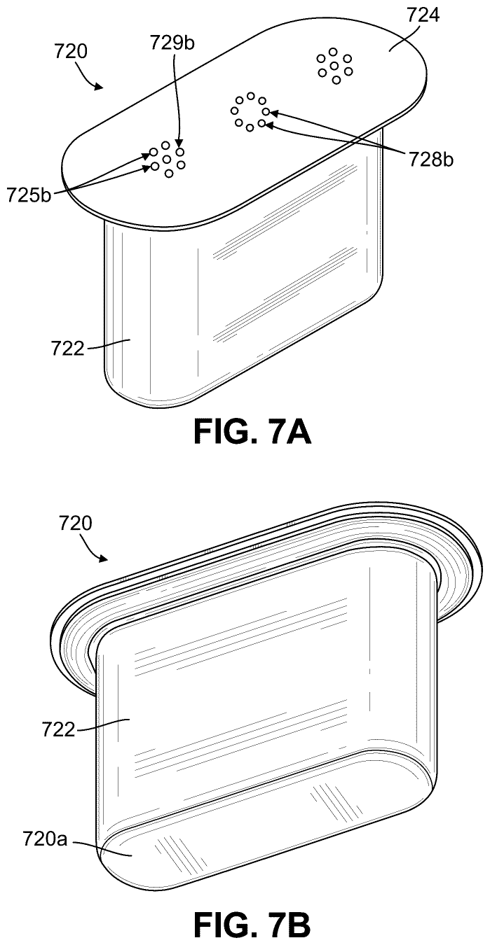

FIG. 7A illustrates a top perspective view of a vaporizer cartridge 720 and FIG. 7B illustrates a bottom perspective view of the vaporizer cartridge 720, consistent with implementations of the current subject matter. As illustrated, the lid 724 of the vaporizer cartridge 720 can include two or more sets of a plurality of through holes. For example, the lid 724 can include two sets of through-holes 725b and entrance holes 729b at opposite sides of the lid 724. Additionally or alternatively, the lid 724 can include a set of exit holes 728b at or near the center of the lid 724. As illustrated, the container 722 of the cartridge 720 can include a bottom or side wall 720a that is substantially parallel to the lid 724.

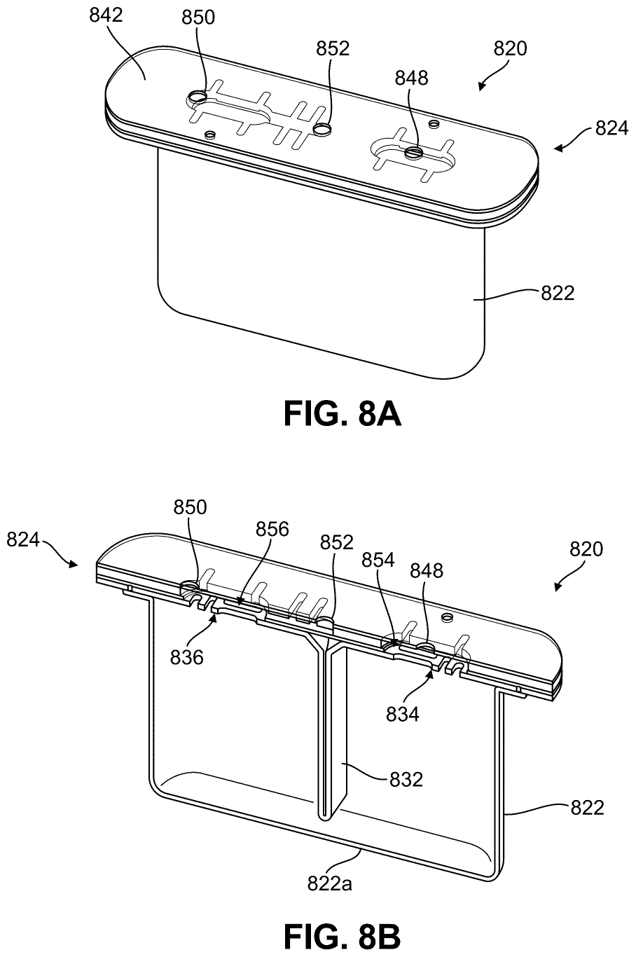

During use, air and vapor will mix within the mouthpiece to generate aerosol for inhalation by a user. As a result, this condensation can generate undesirable build up within the mouthpiece that adversely affects a user's experience with the vaporizer device. This condensation buildup would need to be removed from the mouthpiece throughout the device's use to allow the vaporizer device to work effectively and efficiently. As such, in some implementations, it would be desirable to minimize or avoid condensation forming within the mouthpiece of the vaporizer device. For example, as shown in FIGS. 8A-8B, a vaporizer cartridge 820 can be designed such that condensation is encouraged within the cartridge as opposed to the mouthpiece of a vaporizer device. More specifically, the vaporizer cartridge is designed such that bypass air enters into the cartridge and mixes and cools the vapor within the cartridge into an aerosol for subsequent inhalation by the user (e.g., through a mouthpiece of a vaporizer device). Therefore, condensation that may be generated during the mixing and cooling of the vapor can be otherwise trapped within the vaporizer cartridge prior to exiting (e.g., through exit holes of the lid of the cartridge).

FIG. 8A illustrates a top perspective view of a vaporizer cartridge 820 and FIG. 8B is a cross-sectional view of the vaporizer cartridge 820 consistent with implementations of the current subject matter. The cartridge 820 can be an implementation of one or more components of the cartridge 120 of FIG. 1, configured to hold a vaporizable material 102, and/or configured for use within a vaporizer device such as the vaporizer device 100 of FIG. 1 and/or the vaporizer device 200 of FIGS. 2A-B. While not shown, the cartridge 820 can be configured to be reversibly inserted into a receptacle of a vaporizer device.

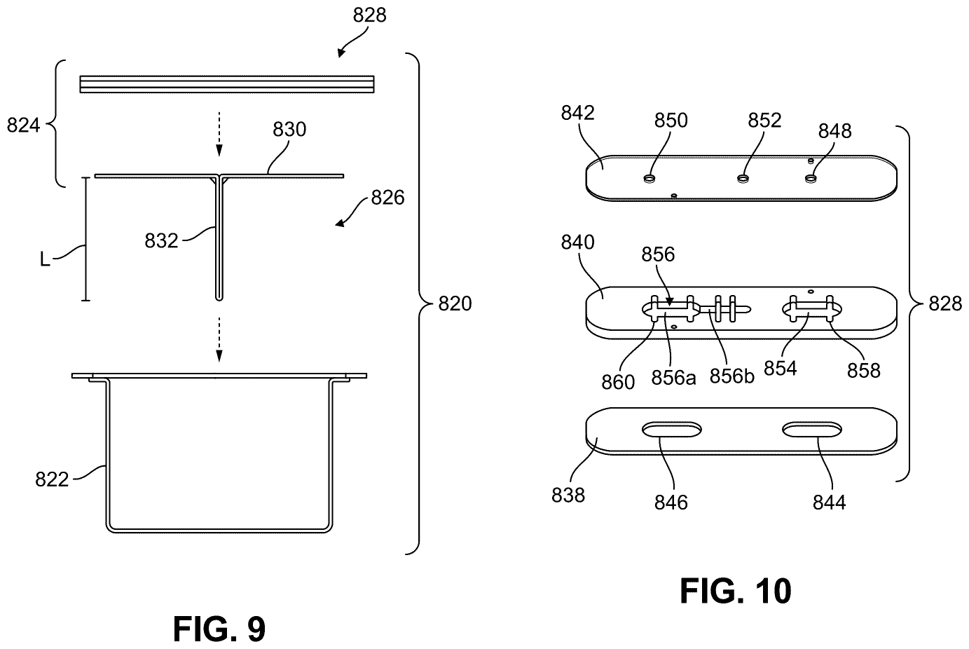

As illustrated, the cartridge 820 can contain two or more components, such as a container 822 and a lid 824. The lid 824 can include one or more different components, such as a base component 826, which is shown in more detail in FIG. 9, and a filter assembly 828, which is shown in more detail in FIG. 10. FIG. 9 is a partially exploded view of the cartridge 820, and FIG. 10 is an exploded view top perspective view of the filter assembly 828.

While the base component 826 can have a variety of configurations, as shown in FIGS. 8B and 9, the base component 826 has a base 830 and a baffle 832 extending therefrom and into the container 822. Although the baffle 832 is illustrated as a single baffle and positioned central to the base 826, in some implementations, the baffle 832 can include two or more baffles or the single baffle can be off-center. In use, the baffle 832 can be configured to direct air that enters the container 822 through the vaporizable material (not shown) within the container 822 to form a vaporized material. The baffle 832 can have a variety of configurations. For example, in some implementations, as shown in FIGS. 8B and 9, the baffle 832 can have an elongated and substantially planar configuration and can extend a length L into the container 822 (e.g., when the base component 826 is attached to the container 822 (see e.g., FIG. 8B). The base component 826 can be attached to the container 822 in a variety of ways, such as for example, welding (e.g., laser welding), adhesion, snap-fit, magnetic attraction, and the like. Further, as shown in FIG. 8B, the baffle 832 is spaced a distance from a bottom wall 822a of the container 822 so that air can travel through the container 822, and consequently, through the vaporizable material housed therein.

Further, the base component 826 includes a plurality of through-holes extending through the base 830. While the number and size of the plurality of through-holes can vary, in the illustrated implementation, there is a first plurality through-holes 834 and a second plurality of through-holes 836. Both the first and second plurality of through-holes 834, 836 can be in fluid communication with the container 822. In use, the first plurality of through-holes 834 can be configured to deliver air to or towards the container 822, and the second plurality of through-holes 836 can be configured to withdraw air from the container 822.

As further shown in FIGS. 8A and 8B, the filter assembly 828 can be coupled to the base component 826. The filter assembly 828, as shown in more detail in FIG. 10, can include two or more components, such as a first layer 838 (e.g., a bottom layer), an absorbent layer 840, and a second layer 842 (e.g., a top layer). In other implementations, the filter assembly can include an absorbent layer and one or more layers, such as the first layer or the second layer. In yet other implementations, the filter assembly includes three or more layers.

While the first and second layers 838, 842 can be formed of a variety of materials, in some implementations, the first layer 838, the second layer 842, or both can function as an adhesive layer. As such, the first layer 838, the second layer 842, or both can include one or more adhesive materials. Alternatively, or in addition, the first layer 838, the second layer 842, or both can include paper, plastic, ceramic, and/or the like. The absorbent layer 840 can include one or more materials, such as paper, plastic, cotton, cellulose acetate, ceramic, and/or the like, and can be configured to absorb condensation formed by the mixing of air (e.g., bypass air that is introduced into the cartridge 820) and vaporized material (e.g., formed within the cartridge 820) to form an inhalable aerosol that exits the cartridge 820 (e.g., towards a mouthpiece of a vaporizer device) for inhalation by a user. As a result, the absorbent layer 840 can help avoid condensation buildup that would otherwise occur within a mouthpiece that is in fluid communication with the cartridge 820.

While the first layer 838 can have a variety of configurations, as illustrated in FIGS. 8B, 9, and 10, the first layer 838 can be positioned adjacent to (e.g., directly adjacent to) the base component 826 and can include two through-holes 844, 846. The first through-hole 844 can be configured to align with at least a portion of the first plurality of through-holes 834 of the base component 826 and the second through-hole 846 can be configured to align with at least a portion of the second plurality of through-holes 836 of the base component 826 (see FIG. 8B). As such, the first through-hole 844 can be in fluid communication with the first plurality of through-holes 834 and the second through-hole 846 can be in fluid communication with the second plurality of through-holes 836. As a result, in use, the first through-hole 844 can be configured to deliver air to or towards the container 822, and the second through-hole 846 can be configured to withdraw air and vaporized material from the container 822.

The second layer 842 can have a variety of configurations. In some implementations, the second layer 842, as illustrated in FIGS. 8A, 8B, and 10, can include one or more through-holes. More specifically, in this illustrated implementation, the second layer 842 includes an air inlet hole 848 that can be configured to allow air to enter into the cartridge 820 and into the container 822, a bypass inlet hole 850 that can be configured to allow air to enter the cartridge 820 and into the filter assembly 828, thereby bypassing the container 822, and an outlet hole 852 that can be configured to allow inhalable aerosol formed within the filter assembly 828 to exit the cartridge 820 for inhalation by a user. As further illustrated, the second layer 842 can be the top-most layer (e.g., outer-most layer of the filter assembly 828, at an end of the cartridge).

As shown in FIGS. 8B, 9, and 10, the absorbent layer 840 can be interposed between the first and second layers 838, 842 and can include at least two through through-holes 854, 856. The first through-hole 854 can be configured to align with at least a portion of the first through-hole 844 of the first layer 838 and with the air inlet hole 848 of the second layer 842 (see FIG. 8B). The second through-hole 856 can be configured to align with at least a portion of the second through-hole 846 of the first layer 838 and the bypass inlet hole 850 and the outlet hole 852 of the second layer 842.

As discussed in more detail below, the second through-hole 856 of the absorbent layer 840 can be configured to serve as a condensation chamber of the cartridge 820. More specifically, the second through-hole 856 has a first segment 856a that overlaps with the bypass inlet hole 850 and a second segment 856b that overlaps with the outlet hole 852 of the second layer 842. The second segment 856b also overlaps with a portion of the first layer 838 that is substantial, or completely, flat, thereby defining a longer airflow path compared to a conventional cartridge in which there is only a straight airflow path up and out of the mouthpiece of a vaporizer device. In use, this configuration in combination with the second plurality of through-holes 836 of the base component 826 allows outside air to mix with the vaporized material such that an inhalable aerosol can be formed within the second through-hole 856 of the absorbent layer 840 prior to exiting the cartridge 820, and ultimately passing through a mouthpiece of a device to a user for inhalation. Since the air entering the cartridge 820 through the bypass inlet hole 850 is relatively cooler compared to the air mass containing the vaporized material from the container, the mixing thereof promotes nucleation of the vaporized material into an inhalable aerosol, as described above. By generating aerosol within the cartridge 820 (e.g., within the condensation chamber of the cartridge), condensation buildup that would otherwise occur within the mouthpiece can be avoided.

Further, the absorbent layer 840 can include one or more channels 858, 860 defined in the absorbent layer 840. For example, as shown in FIG. 10, the absorbent layer 840 can include one or more first channels 858 that are positioned such that they intersect the first through-hole 854 and can include one or more second channels 860 that are positioned such that they intersect the second through-hole 856. The one or more first and second channels 858, 860 can be configured to draw condensation formed within each respective first and second through-holes 854, 856 of the absorbent layer 840 away from the through-holes 854, 856 to help further avoid condensation buildup within the mouthpiece.

FIG. 11 is a magnified view of the cartridge 820 shown in FIG. 8B and illustrates the airflow paths (illustrated by arrows) of the cartridge 820 during use. When a user puffs on a mouthpiece of a vaporizer device comprising the cartridge 820, as illustrated, air enters through the cartridge 820 along a first airflow path 862 which is defined at least in part by the air inlet hole 848 of the second layer 842, the first through-hole 854 of the absorbent layer 840, the first through-hole 844 of the first layer 838, and the first plurality of through-holes 834 of the base component 826. That air enters the container 822 and travels along a second airflow path 864, which is defined at least in part by the baffle 832 and extends along or proximate a bottom surface of the container 822. While the air is passing through the container 822 it is heated by a heater of a vaporizer device (e.g., like heating element(s) 441 of device 400a of FIG. 4A) and vaporizes at least a portion of the vaporizable material (not shown) that is housed within the container 822. Thereafter, the air and vaporized material exit the container 822 through the second plurality of through-holes 836 of the base component 826 and travels along a third airflow path 866 that is defined in part by the second through-hole 856 in the absorbent layer 840. While the air and vaporized material travel along the third airflow path 866, they mix with air present within the second through-hole 856 that enters the third airflow path 866 by way of the bypass inlet hole 850 of the second layer 842. This mixing promotes the nucleation of the vaporized material into an inhalable aerosol (e.g., for subsequent inhalation by a user). Further, the bypass ratio is dictated at least in part by the diameter of the bypass inlet hole 850 relative to the diameter of the air inlet hole 848. As such, the restriction on the lid 824 can be controlled by the relative sizes of the bypass and air inlet holes 850, 848. Thus, the bypass ratio allows for the generation of desired aerosol droplet size to be controlled at least by the cartridge as opposed to, for example, a mouthpiece of the vaporizer device.

In some implementations, the bypass ratio can be greater than one (e.g., the size of the bypass inlet hole is larger than the size of the air inlet hole). In some implementations, the bypass ratio can be less than one (e.g., the size of the bypass inlet hole is smaller than the size of the air inlet hole). In implementations where the bypass ratio is greater than one, a greater amount of cooler air can be introduced into the third airflow path (e.g., third airflow path 866) by way of the bypass inlet hole, and subsequently, can be mixed with the air and vaporized material that exit the container (e.g., air and vaporized material traveling along the third airflow path 866). This can result in a lesser amount of nicotine within the cooler inhalable aerosol compared to when the bypass ratio is less than one.

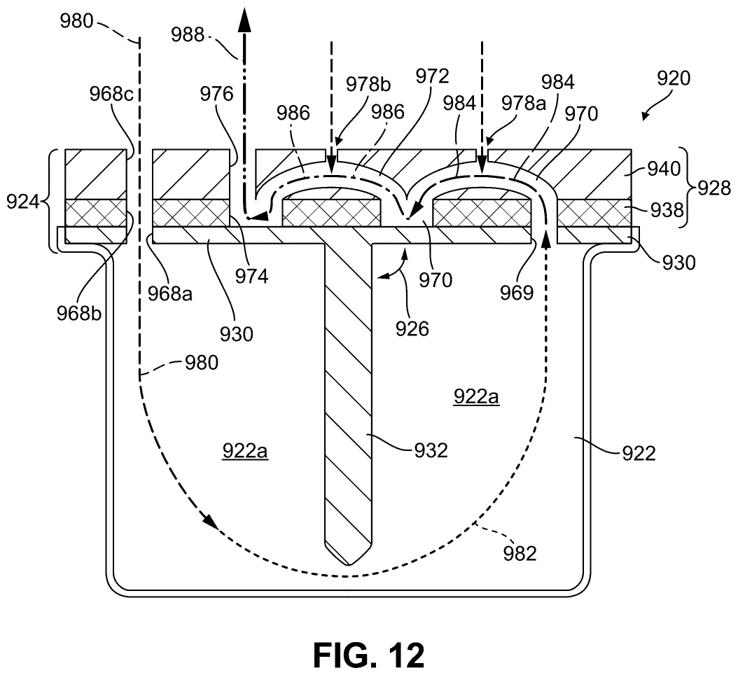

In some implementations, the filter assembly can be designed with increased dead space within the condensation chamber, for example as shown in FIG. 12. This increased dead space can help slow down the velocity of the vapor traveling through the absorbent layer and/or lengthen the airflow path, and as a result, promote nucleation of the vaporized material into an inhalable aerosol (e.g., for subsequent inhalation by a user).

FIG. 12 illustrates a cross-sectional view of an exemplary vaporizer cartridge with increased dead space (e.g., compared to the vaporizer cartridge 820). Aside from the differences described below the vaporizer cartridge 920 is similar to the vaporizer cartridge 820 and therefore similar components are not discussed in detail herein. The vaporizer cartridge 920 in FIG. 12 includes a container 922 and a lid 924.

The lid 924 includes a base component 926 having a base 930 and a baffle 932, and a filter assembly 928 disposed on a surface of the base 930. The filter assembly 928 includes an adhesive layer 938 and an absorbent layer 940, where the adhesive layer 938 is positioned between the absorbent layer 940 and the base 930 of the base component 926. The absorbent layer 940, the adhesive layer 938, and the base 930 each have a respective first through-hole 968a, 968b, 968c. The first through-holes 968a, 968b, 968c at least partially overlap and collectively form an air inlet that can allow outside air (e.g., relative to the cartridge 920) to pass into the container 922. Further, the base component 926 has a second through-hole 969 that is in fluid communication with the interior 922a of the container 922 and is in fluid communication with a first channel 970 defined within the filter assembly 928 (e.g., within the adhesive layer 938 and/or the absorbent layer 940). The second through-hole 969 can allow air and vaporized material (not shown) within the container 822 to exit the container 822 and flow into the first channel 970 for nucleation.

As further illustrated, the first channel 970 is in fluid communication within a second channel 972 defined within the adhesive layer 938 and the absorbent layer 940. As such, the second channel 972 is downstream of the first channel 970. The second channel 972 is in fluid communication with a second through-hole 974 extending through the adhesive layer 938 and a second through-hole 976 extending through the absorbent layer 940. The second through-holes 974, 976 at least partially overlap and collectively form an air outlet that can allow inhalable aerosol to exit the cartridge for inhalation. The first and second channels 970, 972 within the filter assembly 928 define the condensation chamber within the filter assembly 928.

The first and second channels, 970, 972 can have a variety of shapes and sizes. In some implementations, as illustrated in FIG. 12, the first and second channels 970, 972 each have an arc-like shape. More specifically, the first and second channels 970, 972 collectively are a series of arc-like shaped bends. In other implementations, the first channel 970 and/or the second channel 970, 972 can have other types of sizes and shapes, e.g., rectangular, pill shaped, or any other suitable shape that can allow nucleation of the vaporized material. In certain implementations, the first channel 970 and the second channel 972 can have different shapes and/or sizes relative to each other.

Further, the absorbent layer 940 includes at least one aeration hole 978a, 978b that is defined therein and in fluid communication within the outside air (e.g., relative to the cartridge 920). While the number of aeration holes can vary, in some implementations, as shown in FIG. 12, the absorbent layer 940 includes a first aeration hole 978a and a second aeration hole 978b downstream of the first aeration hole 978b. The first aeration hole 978a is in fluid communication with the outside air and the first channel 970, whereas the second aeration hole 978b is in fluid communication with the outside air and the second channel 972.

In use, outside air enters through the first through-holes 968a, 968b, 968c (e.g., air inlet) and into the container 922 along a first airflow path (illustrated by arrow 980). The air continues to travel along a second airflow path 982 that extends along or proximate a bottom surface of the container 922. While the air is passing along or proximate a bottom surface of the container 922 it is heated by a heater of a vaporizer device (e.g., like heating element(s) 441 of device 400a of FIG. 4A) and vaporizes at least a portion of the vaporizable material (not shown) that is housed within the container 922. Thereafter, the heated air and vaporized material exit the container 822 through the second through-hole 969 of the base 930 and into the first channel 970 where it travels along a third airflow path 984 through the first channel 970. While the air and vaporized material passes through the first channel 970 it comes into contact with a first amount of outside air present within the first channel 970 by way of the first aeration hole 978a and the nucleation of the vaporized material into an inhalable aerosol begins. This mixture then passes along a fourth airflow path 986 through the second channel 972 where it comes into contact with a second amount of outside air present within the second channel 972 by way of the second aeration hole 978b and the nucleation of at least a portion of the remaining vaporized material into an inhalable aerosol occurs. The inhalable aerosol then travels along a fifth airflow path 988 through the outlet of the cartridge 920 for inhalation by a user. In this implementation, the outlet is defined by the second-though holes 974, 976 of the adhesive layer 938 and the absorbent layer 940.

In some implementations, it may be desirable to control an amount of nicotine provided to a user over a given period of time (e.g., 2 milligrams of nicotine over 10-12 puffs). However, in some aspects, nicotine transfer can be efficiently and/or effectively delivered via the vaporizer devices described herein (e.g., one or more of the vaporizer devices 100, 200, 400, 500, 1000, 1100), which can result in quickly depleting all or substantially all of the nicotine available within a cartridge (e.g., cartridges 120, 320, 420, 520, 620, 720, 820, 920, 1020, 1120), such as when the cartridge contains an amount of tobacco and/or tobacco leaves similar to one combustible cigarette. Accordingly, a substance other than tobacco leaves can be included within the cartridge in order to control the amount of nicotine delivered over the course of use of a cartridge. It will be appreciated that “tobacco leaves” can refer to dried and/or dehydrated tobacco leaves.

In order to effectively control the amount of nicotine, a substance that has characteristics similar to at least some of the characteristics of tobacco leaves (e.g., characteristics other than the presence of nicotine) can be included within the cartridge along with tobacco leaves and a humectant or other aerosol forming material or carrier (e.g., PG, VG, and/or the like). In some aspects, the characteristics of tobacco leaves that may be desirable to match include heat transfer when saturated with a humectant and/or heat transfer when not saturated with a humectant (collectively referred to as a heat transfer profile), air transfer when saturated with a humectant and/or air transfer when not saturated with a humectant (collectively referred to as an air transfer profile), capillary pressure when saturated with a humectant and/or capillary pressure when not saturated with a humectant (collectively referred to as a capillary pressure profile), porosity when saturated with a humectant and/or porosity when not saturated with a humectant (collectively referred to as a porosity profile), and/or the like. Substances that have characteristics similar to at least some of the characteristics of tobacco leaves can include puffed-up tobacco stems, hemp, cotton, wood, porous glass beads, porous ceramic, and/or the like.

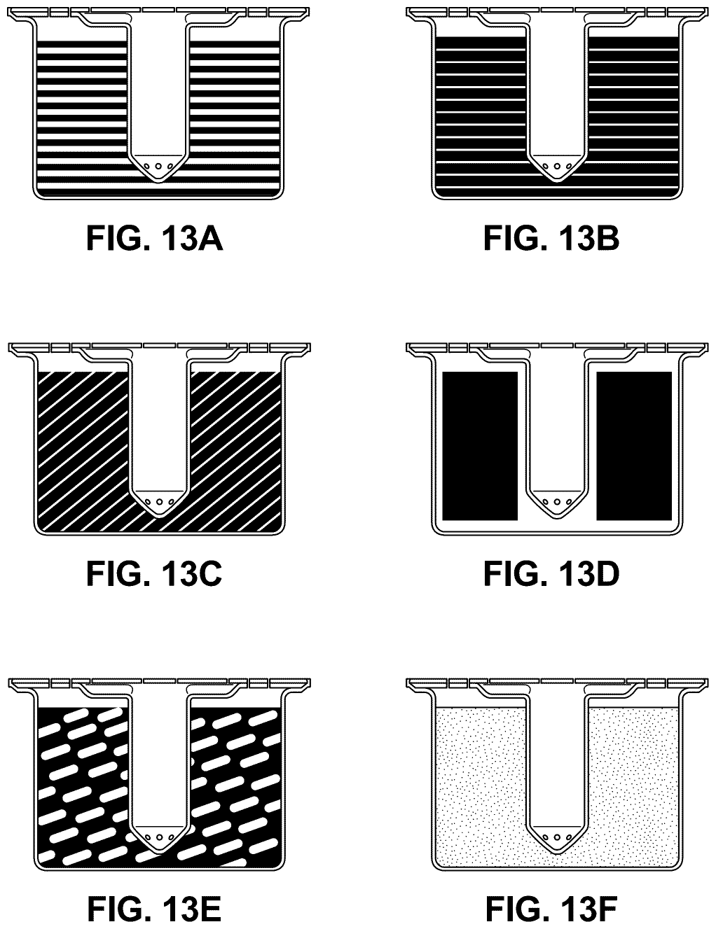

As illustrated in FIGS. 13A-13F, in various implementations, tobacco leaves may be combined in the cartridge with substance(s) that have characteristics similar to at least some of the characteristics of tobacco leaves in different amounts and/or according to different procedures or mechanisms. For example, in some implementations, the tobacco leaves and the substance can be present in approximately a 50/50 ratio, approximately a 55/45 ratio, approximately a 60/40 ratio, approximately a 65/35 ratio, approximately a 70/30 ratio, approximately a 75/25 ratio, approximately a 80/20 ratio, or approximately a 85/15 ratio (with either more of the tobacco leaves or more of the substance being present). One or both of the tobacco leaves and the substance can be formed and/or layered in sheets or strands (e.g., similar to the sheets of FIGS. 13A-13B vertically aligned with respect to the bottom of the cartridge, similar to the sheets of FIG. 13C diagonally aligned with respect to the bottom of the cartridge, in sheets aligned vertically with respect to the bottom of the cartridge, and/or the like), formed into block(s) or other shapes of one surrounded by the other (e.g., similar to the at least two blocks of tobacco leaves surrounded by the substance of FIG. 13D), formed into pellets, boluses, beads, or other three-dimensional shapes of one ordered, interspersed, and/or interpenetrating within the other (e.g., similar to the interspersed substance within the tobacco leaves of FIG. 13E), blended together into a homogenous or non-homogenous mixture (e.g., similar to the mixture of FIG. 13F), disposed to occupy different portions of the cartridge (e.g., front and back, left and right, and/or the like), and/or the like.

In some aspects, the amounts and/or procedures or mechanisms by which the tobacco leaves and the substance are combined can affect the rate at which nicotine is extracted from the tobacco leaves during the course of a vaporizer device session. In order to achieve a vaporizer device session that will be satisfying to a combustible cigarette user, it can be desirable to combine the tobacco leaves and the substance in a manner that enables the humectant and nicotine to be substantially depleted as close in time as possible. It will be appreciated that “substantially depleted” can refer to conditions under which aerosol production drops off, the harsher taste of nicotine is not as noticeable, or a burnt taste is detected.

Accordingly, when combined with tobacco leaves and humectant, and heated at lower temperatures (e.g., 300 degrees to 400 degrees Fahrenheit or 150 degrees to 200 degrees Celsius), substances with characteristics similar to at least some of the characteristics of tobacco leaves can retain and release humectant at the same or similar rate to that of tobacco leaves, making aspects of the vaporizer device experience substantially the same as the experience of smoking a combustible cigarette.

Although the vaporizable material (e.g., tobacco leaves and/or substance with characteristics similar to at least some of the characteristics of tobacco leaves) is illustrated as occupying approximately 90% of the interior volume of the cartridge, in some implementations the vaporizable material may occupy approximately 80% of the interior volume of the cartridge, approximately 70% of the interior volume of the cartridge, approximately 60% of the interior volume of the cartridge, approximately 50% of the interior volume of the cartridge, or less. It will be appreciated that, in some aspects, the interior volume of the cartridge may include or exclude the space occupied by other components of the cartridge (such as the shaft 326, 426, 526, 626).

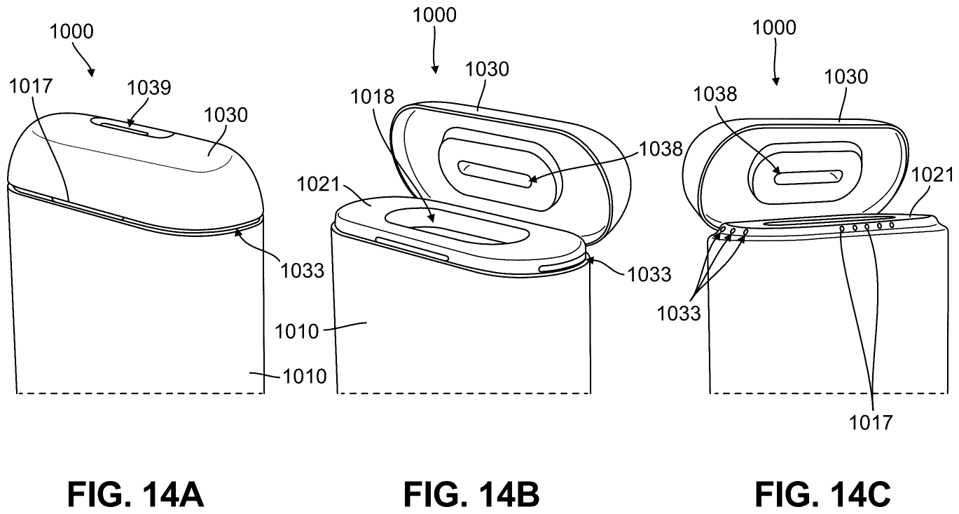

FIGS. 14A-14C illustrates top perspective views of vaporizer device 1000, consistent with implementations of the current subject matter. As illustrated in FIG. 14A, the vaporizer device 1000 can include a vaporizer body 1010 and a mouthpiece 1030, having an airflow outlet 1039, attached to the vaporizer body 1010. In some implementations, when the mouthpiece 1030 is closed on the top of the vaporizer body 1010, the shape of mouthpiece 1030 can be such that a portion of the top of the vaporizer body 1010 is occluded (e.g., at least a portion of the ledge 1021) while another portion of the top of the vaporizer body 1010 remains exposed. Within this exposed region, one or more airflow inlets 1033 may be at least partially exposed (e.g., to ambient air). Additionally or alternatively one or more outputs 1017 in the form of at least one LED (e.g., in the form of a solid light bar) can be provided within the exposed region between the intersection of the vaporizer body 1010 and the mouthpiece 1030.

As illustrated in FIG. 14B, the mouthpiece 1030 of the vaporizer device 1000 can be opened to provide access to a receptacle 1018 (e.g., for insertably receiving a cartridge 120, 220, 320, 420, 520, 620, 720, 1020). In some implementations, airflow can be provided to a cartridge in the receptacle 1018 via the one or more airflow inlets 1033, illustrated as a slit, which can be substantially the same on the opposite side of the vaporizer body 1010. As illustrated, the underside of the mouthpiece 1030 can include an airflow outlet channel 1038 in fluid communication with the airflow outlet 1039.

As illustrated in FIG. 14C the one or more airflow inlets 1033 in the vaporizer body 1010 may instead take the form of a plurality of through-holes. Additionally or alternatively, as illustrated the one or more outputs 1017 in the form of at least one LED can comprise a plurality of LEDs (e.g., in the form of a strip of five LEDs). The vaporizer device 1000 can include the same components of, and otherwise operate in the same manner as, any of the vaporizer device 100 of FIG. 1, vaporizer device 200 of FIGS. 2A-2B, vaporizer devices 400a-i of FIGS. 4A-4I, vaporizer device 500 of FIGS. 5A-5B, and/or any other vaporizer device described herein, except as noted.

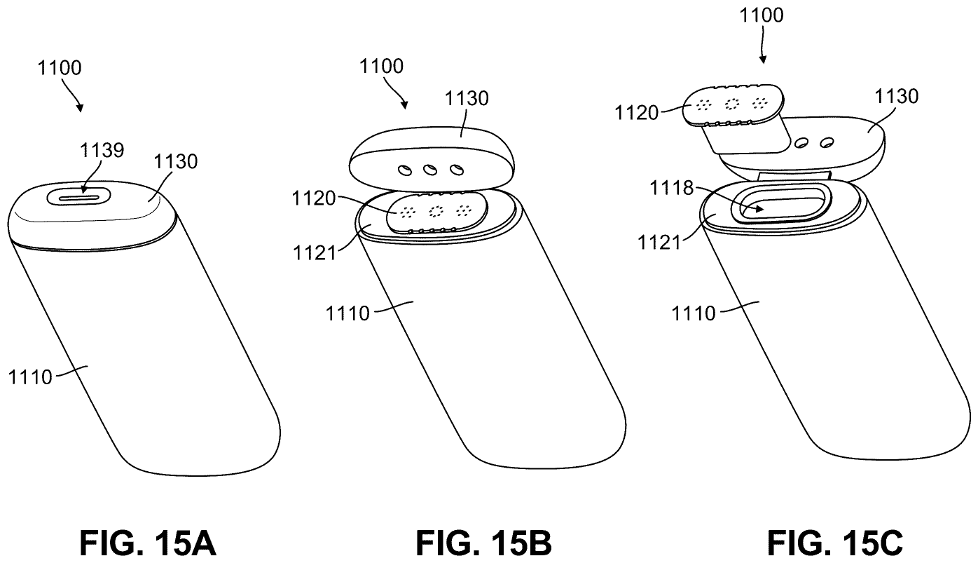

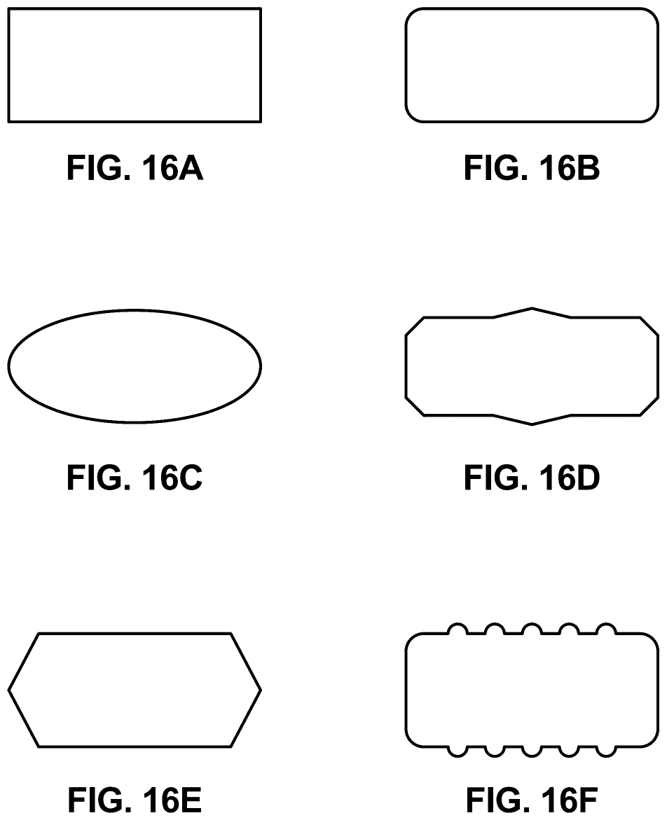

FIGS. 15A-15C illustrates top perspective views of vaporizer device 1100, consistent with implementations of the current subject matter.

As illustrated in FIG. 15A, the vaporizer device 1100 can include a vaporizer body 1110 and a mouthpiece 1130, having an airflow outlet 1139, attached to the vaporizer body 1110. As illustrated in FIG. 15B, the mouthpiece 1130 of the vaporizer device 1100 can be opened to reveal a cartridge 1120 within the vaporizer body 1110. As further illustrated, a lid of the cartridge 1120 can rest upon at least a portion of the ledge 1121 of the vaporizer body. As illustrated in FIG. 15C, the cartridge 1120 can be removed from the receptacle 1118 of the vaporizer body 1110 (e.g., for disposal after use). As further illustrated, the shape of the receptacle 1118 and/or ledge 1121 can be complementary to the shape of the cartridge 1120, which can allow the cartridge to sit lower within the receptacle 1118 while still being easily removable. The vaporizer device 1100 can include the same components of, and otherwise operate in the same manner as, any of the vaporizer device 100 of FIG. 1, vaporizer device 200 of FIGS. 2A-2B, vaporizer devices 400a-i of FIGS. 4A-4I, vaporizer device 500 of FIGS. 5A-5B, vaporizer device 1000 of FIG. 14A-14C, and/or any other vaporizer device described herein, except as noted.

In some implementations, any of the cartridges described herein (e.g., cartridges 120, 220, 320, 420, 520, 620, 720, 820, 920,1120) can include a filter component, such the within any of the shafts described herein (e.g., 326, 426, 526, 626) and/or another location downstream of the shafts. Additionally or alternatively, the vaporizer devices described herein (e.g., one or more of the vaporizer devices 100, 200, 400, 500, 1000, 1100) can include a filter component outside of the cartridge, such as within the airflow outlet channels described herein (e.g., airflow outlet channels 438, 538, 1038). In various implementations, the filter component can be configured to add components to the inhalable aerosol (e.g., flavors such as menthol) or strip components from the inhalable aerosol (e.g., nicotine and/or HPHCS).

The filter component can be similar to a traditional filter such as cellulose acetate and/or could include cotton, charcoal, beads, and/or the like, as long as the construction of the filter component allows airflow therethrough. In some implementations, the filter component can by cylindrical in shape. However, in other implementations the filter component can be an obstruction of any form, such as a baffle, webbing, and/or the like. In some aspects, providing a filter component downstream of where the vaporizable material 102, 402 is heated to form vaporized material can aid in cooling the temperature of the aerosol passing therethrough, restrict or otherwise control airflow, and/or the like.

In any of the implementations described herein, the features defining the airflow path(s) (e.g., holes 425, 525, 625a, 625b, 725b of the cartridges 420, 520, 620, 720) can vary in geometry (e.g., shape, size, angle), location, number, and/or the like. Each of these variables can impact airflow within a vaporizer device 100, 200, 400, 500, 1000, 1100 and the components thereof (e.g., a cartridge 120, 320, 420, 520, 620, 1020, 1120), and may provide drastically different user experiences via providing inhalable aerosols with different properties to a user. Such properties include but are not limited to average particle size, ratio of air to vaporized material, ratio of solid to liquid particles, percentage of active ingredient, temperature, and/or the like, which can be further complicated by properties of the vaporizable material 102, 402 itself (e.g., flavor).

For example, a smaller hole can provide more resistance to airflow attempting to pass through the hole, thereby increasing the velocity, speed, and/or force of the air that does pass through the hole. Conversely, a larger hole can provide less resistance to airflow attempting to pass through the hole, thereby decreasing the velocity, speed, and/or force of the air that does pass through the hole. Due to decreased velocity/speed, a larger hole can provide for increased residence time (e.g., the amount of time heated air is present within the vaporizable material 102, 402), but due to decreased force, a larger hole can reduce the amount of vaporized material that is carried in the airflow path(s) 431, 432, 531, 532, 631, 632. Accordingly, in some implementations, the features defining the airflow path(s) can be tuned to alter the user's experience with the goals of creating an inhalable aerosol with particular properties in mind.

The features defining the airflow path(s) described herein include but are not limited to airflow inlets 433, 434, 533, 1033, airflow channels 435, 436, 438, 535, 538, 1038, airflow outlets 439, 539, 1039, holes and/or channels within the cartridges 120, 320, 420, 520, 620, 1020, 1120 (e.g., including holes 425, 525, a plurality of through-holes 325a, 325b, 625a, 625b, 725b, one or more channels 329a, 529a, 629a, a central opening 328a, 628a, one or more entrance holes 329b, 629b, 729b one or more exit holes 328b, 628b, 728b, one or more shaft through-holes 327, 627, and/or the like), components of the cartridge 120, 320, 420, 520, 620, 1020, 1120 (e.g., including a base component 324a, a perforated lid 324b, a top barrier 324c, container 322, 422, 522, 622, 722, a shaft 326, 426, 526, 626, and/or the like), the vaporizable material 102, 402, and/or the like.

Although “smaller” hole is a relative term and only depends on the existence of a larger hole (of any size), it is contemplated that a smaller hole can include a hole with a diameter that is around 1 mm or less (e.g., 0.5 mm to 1.2 mm). Similarly, although “larger” hole is a relative term, it is contemplated that a larger hole can include a hole with a diameter that is around 1 mm or more (e.g., 1.0 mm to 3.0 mm).

In some implementations, a component of the vaporizer device 100, 200, 400a-i can be configured to cover none, one, or any number of holes to allow a user to customize their experience to their personal preference (e.g., by ultimately affecting the properties of the inhalable aerosol delivered to the user). For example, vaporizer cartridges 120, 320, 420, 520, 620, 720, 1120 may be provided with certain holes covered (e.g., by a sticker), and a user may be able to uncover any number of the covered holes to change their experience. Uncovering one or more of the initially covered holes can change a user's experience by providing additional air to one or more locations within the cartridge, thereby providing a larger airflow stream (e.g., via less restriction), a lower-density vapor (e.g., via less residence time within the cartridge), and/or the like. These optionally exposed or covered air holes can affect either or both of an amount of air that is heated and/or otherwise comes directly into contact with the vaporizable material and an amount of “bypass air” that is combined with the heated air mass containing vaporized material released by heating the vaporizable material. Affecting the ratio of these two air streams can impact temperature of the aerosol inhaled by a user of a vaporizer device and may also affect a distribution of one or more compounds of the vaporized material between the gas and condensed phases when the user receives air passing through the vaporizer device.

Additionally or alternatively, different implementations of vaporizer cartridges 120, 320, 420, 520, 620, 720, 1120 can be sold, such that a user can select a cartridge that provides them with their preferred user experience. Cartridges can also be produced with pre-set air inlet orifices for either or both of the inlet air that is heated and/or passes through or near the heated vaporizable material and bypass air that is not hated but instead joined with a heated air mass containing vaporized material (e.g., one or more compounds converted to the gas phase by heating the vaporizable material). Different cartridges may include different inlet orifice and/or outlet orifice configurations (e.g., cross-sectional orifice area, orifice shape, orifice locations, number of instances of offices, and/or other airflow-impacting characteristics, etc.) for these two air streams to affect characteristics of the resulting aerosol as it is delivered to the user through at least one outlet during inhalation (e.g., based on varying either or both the cross-sectional orifice area and number of orifices in particular locations).

### Terminology

It will be appreciated that the terms “proximal” and “distal” are used herein to refer to relative locations of the referenced devices and/or components. Although “proximal” is generally used to refer to a location that is at or near a user when the device and/or component is in use, and “distal” is generally used to refer to a location that is away from a user when the device and/or component is in use, these terms are not intended to be absolute. For example, a “proximal” end and/or a “distal” end of a component need not be the absolute furthest points on the referenced ends, and can instead refer to a general region at or near the referenced end. Further, opposing “proximal” ends and “distal” ends of a component need not be completely and/or perfectly opposite each other, as the shapes of each end may differ and/or the component may not be perfectly linear (e.g., one or more longitudinal dimensions of the component may be of different lengths).

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present.

Although described or shown with respect to one implementation, the features and elements so described or shown can apply to other implementations. It will also be appreciated by those of skill in the art that references to a structure or feature that is disposed “adjacent” another feature may have portions that overlap or underlie the adjacent feature.

Terminology used herein is for the purpose of describing particular implementations and implementations only and is not intended to be limiting. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

Spatially relative terms, such as “forward”, “rearward”, “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings provided herein.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative implementations are described above, any of a number of changes may be made to various implementations without departing from the teachings herein. For example, the order in which various described method steps are performed may often be changed in alternative implementations, and in other alternative implementations one or more method steps may be skipped altogether. Optional features of various device and system implementations may be included in some implementations and not in others. Therefore, the foregoing description is provided primarily for exemplary purposes and should not be interpreted to limit the scope of the claims.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

The examples and illustrations included herein show, by way of illustration and not of limitation, specific implementations in which the subject matter may be practiced. As mentioned, other implementations may be utilized and derived there from, such that structural and logical substitutions and changes may be made without departing from the scope of this disclosure. Such implementations of the inventive subject matter may be referred to herein individually or collectively by the term “invention” merely for convenience and without intending to voluntarily limit the scope of this application to any single invention or inventive concept, if more than one is, in fact, disclosed. Thus, although specific implementations have been illustrated and described herein, any arrangement calculated to achieve the same purpose may be substituted for the specific implementations shown. This disclosure is intended to cover any and all adaptations or variations of various implementations. Combinations of the above implementations, and other implementations not specifically described herein, will be apparent to those of skill in the art upon reviewing the above description.

1. A vaporizer device for generating an inhalable aerosol, the vaporizer device comprising:
a receptacle;
one or more heating elements positioned to heat the receptacle;
a cartridge configured to be inserted into the receptacle, the cartridge comprising:
a container comprising vaporizable material, the container configured to heat the vaporizable material when the heating element heats the receptacle;
a lid comprising a plurality of first air inlets configured to direct air into the container, the lid further comprising at least one air outlet; and
a structure within the container, the structure configured to direct the air through the vaporizable material to form a vaporized material;
at least one condensation chamber configured to condense the vaporized material into the inhalable aerosol, the at least one condensation chamber in fluid communication with the at least one air outlet; and
a mouthpiece comprising a mouthpiece outlet configured to deliver the inhalable aerosol to a user, the mouthpiece outlet in fluid communication with the at least one condensation chamber.

2. (canceled)

3. The vaporizer device of claim 1, wherein the one or more heating elements are positioned at, against, near, and/or along one or more walls of the receptacle.

4. The vaporizer device of claim 3, wherein the one or more walls of the receptacle comprise a bottom receptacle wall that is distal to the mouthpiece, and wherein the one or more walls of the receptacle further comprise one or more side walls extending in a longitudinal dimension that is perpendicular to the bottom receptacle wall.

5. The vaporizer device of claim 4, wherein a first heating element of the one or more heating elements extends along at least a portion of the one or more side walls of the receptacle.

6. The vaporizer device of claim 4, wherein a first heating element of the one or more heating elements is wrapped around at least a portion of an exterior of the receptacle.

7. (canceled)

8. The vaporizer device of claim 4, wherein a second heating element of the one or more heating elements extends along at least a portion of the bottom receptacle wall.

9. The vaporizer device of claim 4, wherein the bottom receptacle wall comprises a second heating element of the one or more heating elements, and wherein the second heating element is in direct contact with the cartridge.

10.-14. (canceled)

15. The vaporizer device of claim 1, wherein the container of the cartridge comprises a non-vapor permeable material.

16.-18. (canceled)

19. The vaporizer device of claim 1, wherein the structure comprises a baffle or a shaft comprising a plurality of shaft through-holes

20. The vaporizer device of claim 1, further comprising an airflow path configured to deliver the inhalable aerosol to the user, the airflow path comprising the plurality of air inlets, the plurality of through-holes, the at least one condensation chamber, the at least one air outlet, and the mouthpiece outlet.

21. The vaporizer device of claim 19, wherein the shaft comprises the at least one condensation chamber, and wherein the at least one condensation chamber is in fluid communication with one or more of the plurality of air inlets, the one or more of the plurality of air inlets configured to direct air into the at least one condensation chamber to promote nucleation of the vaporized material into the inhalable aerosol.

22. The vaporizer device of claim 1, wherein the mouthpiece comprises the at least one condensation chamber, and wherein the mouthpiece further comprises at least one air inlet in fluid communication with the at least one condensation chamber, the at least one air inlet configured to direct air into the at least one condensation chamber to promote nucleation of the vaporized material into the inhalable aerosol.

23. (canceled)

24. The vaporizer device of claim 1, wherein the mouthpiece further comprises an air inlet configured to direct air into the vaporizer device.

25. The vaporizer device of claim 1, wherein the lid further comprises at least one second air inlet configured to direct air toward a combined airflow path of the vaporized material to thereby promote nucleation of the vaporized material into the inhalable aerosol.

26.-27. (canceled)

28. The vaporizer of claim 1, wherein the structure comprises at least one first hole and at least one second hole, the at least one first hole being configured to direct the air passing through the plurality of air inlets of the lid into the container and the at least one second hole being configured to direct the vaporized material toward the at least one air outlet of the lid, and wherein the combination of the at least one first hole and the at least second hole allows air ingress and air egress into and out of the cartridge through the lid.

29. The vaporizer of claim 28, wherein air ingress through the at least first hole passes through the lid in a first direction, and wherein air egress through the at least one second holes passes through the lid in a second direction that is different than the first direction.

30. The vaporizer of claim 29, wherein the first direction and the second direction are opposite directions relative to each other.

31.-38. (canceled)

39. The vaporizer device of claim 1, wherein the structure comprises a filter upstream of the at least one air outlet.

40. The vaporizer device of claim 1, wherein the structure is further configured to direct the vaporized material towards the at least one air outlet.

41. The vaporizer device of claim 1, wherein the at least one condensation chamber is positioned within the cartridge.

42. The vaporizer device of claim 1, wherein the lid comprises a filter assembly.

43. The vaporizer device of claim 42, wherein the filter assembly comprises a first layer and an absorbent layer, wherein the at least one condensation chamber is defined within the absorbent layer.

44. The vaporizer device of claim 43, wherein the filter assembly further comprises a second layer, wherein the absorbent layer is positioned between the first layer and the second layer.

45. The vaporizer device of claim 44, wherein each of the first layer, second layer, and absorbent layer has at least one through-hole extending therethrough.

46. The vaporizer device of claim 43, wherein the absorbent layer comprises at least one aeration hole, wherein the at least one aeration hole is in fluid communication with the condensation chamber.
